(19) United States
(12) Patent Application Publication
(10) Pub. No.: US 2012/0111010 A1
(43) Pub. Date: May 10, 2012

(54) Method and device for producing electrical or mechanical power from ambient heat using magneto-caloric particles

(76) Inventor: Marc Samuel Geldon, Cape Coral, FL (US)

(21) Appl. No.: 13/271,677

(22) Filed: Oct. 12, 2011

(51) Int. Cl. F03G 7/00

(52) U.S. Cl. 60/721

(57) ABSTRACT

My embodiment drives magneto-caloric material in nanopowder form with pressurized ethane, in a closed loop. Heat from the ethane is used to drive the closed loop and to drive a turbine in the loop that produces work external to the system through external coupling. The heat lost from the ethane is replaced by external heat through a heat exchanger that is part of the closed loop.

### BACKGROUND

### Prior Art

Refrigerators need energy inputted in order to refrigerate. They also need to radiate heat in one space in order to cool in another space. Since my embodiment refrigerates by running off thermal energy that my embodiment absorbs at a high rate, my embodiment does not need any other energy inputted while refrigerating. The energy that was once heat can be stored as kinetic or potential energy such as electricity in a battery, or can be transferred into mechanical work, etcetera, wherever energy would be needed or be useful elsewhere. Hence, this embodiment does not need to radiate heat in one space in order to cool in another space.

Power generators running off thermal energy need some existing heat variation to create power. Without a temperature difference these generators cannot operate. There is only one attempt, U.S. Pat. No. 4,638,194, at explaining a possible way to overcome the need for an external temperature variation through a superconductive effect whereas my embodiment uses a magneto-caloric effect without the need for the magnetocaloric material to be a superconductor. Hence this embodiment is novel in the magneto-caloric field by being the only device that does not need an external temperature difference to create power since this device auto-creates a temperature variation. Also, any other possible patent that is a magneto-caloric generator that does not operate by using a magneto-caloric powder would have to operate at either such at great dimensional size or at such a low magnitude of power that it would be considered impractical for virtually any use. This is the only invention to date that uses a magnetocaloric powder to simultaneously provide power from ambient heat and provide refrigeration with no temperature difference needed.

My embodiment can produce an engine that is of smaller comparable volume to most used in airplanes, automobiles, or boats and is at least as powerful if not more. Instead of using a fuel tank my embodiment uses a heat exchanger. Although, the heat exchanger can optionally be supplemented with fuel as a heat source. If one of my embodiments were planned to replace an automobile engine, the embodiment's heat exchanger would be comparable in size to the automobile's fuel tank and serve the same purpose, to provide energy to the engine.

Instead of functioning as an engine or as a refrigerator, my embodiment can also function as a fuel-less heater. If the device is cooling outside air, the device can also be doing mechanical work as a frictional heater to heat anything, like the inside of a house, or heat electrically by producing electricity by turning an electric generator. Besides running off the thermal energy in ambient air, the embodiment can also run off the thermal energy in a liquid like water, a solid, or any combustible fuel.

Since the embodiment can cool air so rapidly, the embodiment can also be used as a potable water source by using the heat exchanger like a distillation column, condensing water from air very quickly.

The general life time and reliability of a regular gasoline engine or a regular refrigerator is very poor compared to the device embodied. The reason for designs, other than this embodied, to have very poor lifetimes and reliabilities is that they suffer from mechanical contact of their internal parts, and from corrosive materials used within them, ultimately causing them to fail early. Since there is no touching of parts mechanically within any embodiment except the touching of a magneto-caloric material in nanopowder form with other internal parts of the embodiments, the reliability and overall lifetime of each embodiment is excellent. Also, no corrosive substances are needed within any embodiment. Even the very small amount of mechanical contact can safeguarded by applying ultra-tough thin films in places where the probability for abrasion by the nanopowder is increased due to increased velocity of the nanopowder in certain high velocity regions.

The magneto-caloric effect of a material as used herein is defined as a material property which manifests itself as a self-heating up of the material as it enters a magnetic field, and likewise, a self-cooling of the material to its previous temperature as it leaves a magnetic field; unless, the material had been externally cooled when the material had internally heated up, which in case, the material becomes colder upon exiting the magnetic field than the material originally was. An example of a known material for a giant magneto-caloric effect is the alloy Gd₅(Si₂Ge₂). This magneto-caloric effect is also used in refrigerators that allow us to reach the closest to absolute zero Kelvin. These previous refrigerators differ from this invention in that the previous refrigerators need energy other than thermal energy to cool, whereas this embodiment only needs thermal energy. Hence, previous refrigerators do not generate energy to operate, they use energy to operate; whereas, this embodiment generates energy to refrigerate. There are many different magneto-caloric materials. Many magneto-caloric materials vary in their strength of magneto-caloric effect depending upon the percentages of constituents making up the material. Varying these percentages usually gives ranges that are variable that produce a few degrees or more of temperature change within those ranges. There are many different choices available depending upon operating temperature of the resultant embodiment with things like varying market price also being an important variable that goes into choosing the more optimal material. Gd₅(Si_{X}Ge_{1-X})₄ is a great choice since it produces a large temperature change of about 4 to 16 degrees for a smaller magnetic field change around 5 Tesla over a decent range of 50 degrees Kelvin in temperature, with the range midpoint being a function of X. The expensive element germanium, like many rare earth elements used in these materials, is somewhat limiting and dictates that other cheaper materials will also be used, albeit with permissibly smaller magneto-caloric effects or needing larger magnetic fields because of their smaller magnetocaloric effects, to meet all the complexities of price and demand constraints covering all modes of operation: high & low power density power generation, refrigeration, heating, and potable water.

The preferred embodiment operates with two types of magnets. The first type is a high strength permanent magnet. This type loses less than 1% of its field every decade, allowing a very long time before it needs to be re-magnetized. Permanent magnets are limited in their field strength though and are only theoretically able to achieve up to 1.2 Tesla in there magnetic field. Permanent magnet's magnetic fields tend to be much less consistent than superconducting magnets. Magneto-caloric materials generally need magnetic fields between 2 Tesla and 10 Tesla to produce significant magnetocaloric effects. To achieve these high fields while using very little energy input, the second type of magnet is used which is the air-core superconducting type. Since the resistance is so low in the superconductors of superconducting magnets, superconducting magnets dissipate very little power. Superconducting magnets only need to be recharged around every couple of months due to their power dissipation.

The temperature at which a superconducting magnet super-conducts is its critical temperature. Generally, the more a superconductor is below its critical temperature, the larger of a magnetic field a superconductor can create without quenching. Quenching is what happens when a superconductor's field is exceeded and the superconductor stops superconducting. The majority of superconducting magnets use low temperature, type-1 superconductors, and operate at less than 10 Kelvin but emerging high temperature superconductors have critical temperatures nearer to 120 kelvin. High temperature superconducting magnets tend to be cooled to around 60 kelvin, but can be cooled less depending upon the magnetic field strength sought.

No prior art in patent searches was found that showed a likeness to this invention. However, all prior patents that appear to be in the realm of this application are listed in this application's Information Disclosure Statement's form. In addition, no prior patent was found that encompassed the breadth of utility that this invention does, nor is there any other patent similar to this invention as of this writing. U.S. Pat. No. 7,596,955 is the only other patent to use a magnetocaloric powder, but that patent does not capitalize on the high heat transfer rate of a powder as does this embodiment. U.S. Pat. No. 7,596,955's purpose is only to create a heat flux by inputting power as any regular refrigerator does, which is vastly different in operating principle than this invention. U.S. Pat. No. 7,596,955 uses work to transfer heat whereas this invention produces work to convert heat. This invention is the only patent to produce work by converting heat that is not at a temperature difference besides U.S. Pat. No. 4,638,194 that uses a different, superconductive, effect than this embodiment. Also, this is the only patent to generate power by using a magnetocaloric powder. Any patent claiming magnetocaloric power generation from thermal energy without using a magnetocaloric powder would have a miniscule power generation output capacity many orders less in magnitude compared to this patent. The reason for the increased power capacity is because a powder has an enormous heat transfer rate which allows for enormous conversion of thermal energy into mechanical energy. Using a magnetocaloric powder for its increased heat transfer rate and capitalizing on the resultant heat transfer rate is novel in this patent. Magnetocaloric material such as a solid or as chunks cannot have as high of a heat transfer rate as that of a powder. Thus, magnetocaloric materials in forms other than a powder cannot operate at as high of a power rate as the embodiments herein.

Patent 20060144048 claims to convert heat into mechanical or electrical power. Patent 20060144048 does not use a magnetocaloric powder to produce rapid heat transfer throughout the working medium as this patent does though. Patent 20060144048 states that it does not simultaneously generate power and cold as this invention does. Patent 20060144048 uses the shape memory effect, for generating power whereas this invention does not need to use the shape memory effect for power generation. Patent 20060144048 seems to need and use a temperature difference which this invention does not need present. Patent 20060144048 uses a working fluid in only the liquid phase.

This invention is novel compared to previous attempts at a device that produces power and refrigeration simultaneously like patent EP0308611.

There are two frost-less heat exchangers in prior art. U.S. Pat. No. 7,788,943 uses mechanical scraping to get rid of ice. Mechanical scraping is mentioned in this embodiment, but mechanical scraping is not as optimal as other frost-less heat exchangers divulged. U.S. Pat. No. 6,988,374 uses an anti-freeze that flows over the surface of the heat exchanger. Another anti-freeze based heat exchanger is used herein that is more optimal, novel, and non-obvious. Instead of applying a light coat of anti-freeze to the heat exchanger, the heat exchanger sits in a vat of anti-freeze. Air to heat the heat exchanger is bubbled through the anti-freeze. This is more optimal because there will be a higher heat transfer rate from the air to the heat exchanger. This higher heat transfer rate is because a liquid-solid interface has a higher heat transfer rate, and because the air bubbles will have a higher heat transfer rate into the anti-freeze due to their extra density from being compressed, and because of their high surface area to volume ratio.

### SUMMARY

The present invention concerns a device that runs off of external ambient thermal energy, even when the external temperature is colder than −50 degrees Celsius, without the constraint of requiring an existing heat difference or differential. The device can power something ranging from smaller than a moped to larger than a fighter jet. The device can output electrical power or mechanical power. The device has a reliability and efficiency far greater than any other engine or refrigerator. The device can run off of combustible fuel or run without combustible fuel.

The device runs off of a pressure difference powering the device's internal components. The pressure difference is created by a magnetic field, from the superconducting magnet assemblies (419 & 537), within the heat wheels (420 & 955). This magnetic field creates a temperature difference in each half of each heat wheel by heating up and cooling down a magneto-caloric nanopowder in each half of each heat wheel respectively, which in turn creates a temperature difference in the internal atmosphere of the heat wheels which in turn creates the pressure difference. The heating up and cooling down of a magnetocaloric powder can take place in less than half of a heat wheel as exemplified by the fourth embodiment.

The device produces work by lowering the engine's internal temperature to a temperature below about 110 Kelvin, which in turn makes more heat flow into the engine by thermodynamical laws when the outside temperature is higher than the internal temperature, thus making a repeating cycle. An internal operating temperature below 110 Kelvin is typical for most embodiments, while other possible embodiments have an internal operating temperature at or much higher than 110 Kelvin.

Virtually any engine design can be converted to work on this devices principles, and when an engine is converted, the engine can be said to be of an embodiment herein and will infringe. Since the device converts heat, the device can also be used as a refrigerator. Since the device refrigerates at great power and at such cold temperatures, the device can be used to cool superconductors of vast lengths. Other uses for the device are also possible, such as being a potable water source by condensing water, or powering homes by generating electrical energy, or heating a home by generating mechanical energy in a friction based heater, etcetera.

### DRAWINGS

### Figures

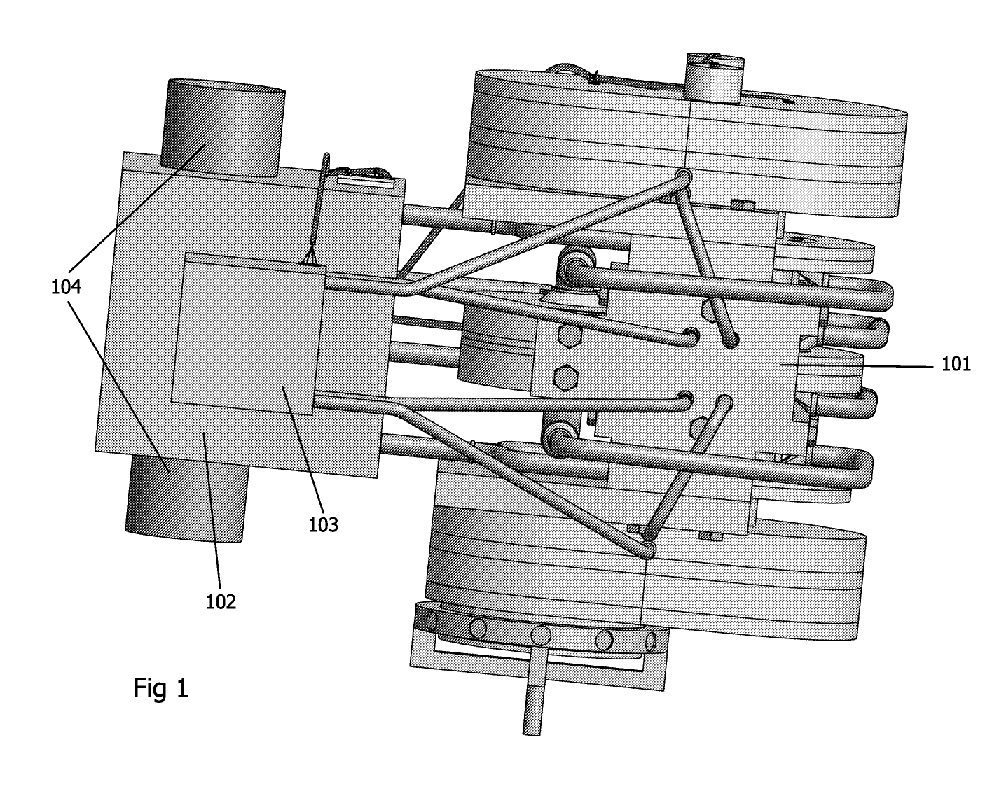

FIG. 1 is a custom angled view, with all parts included

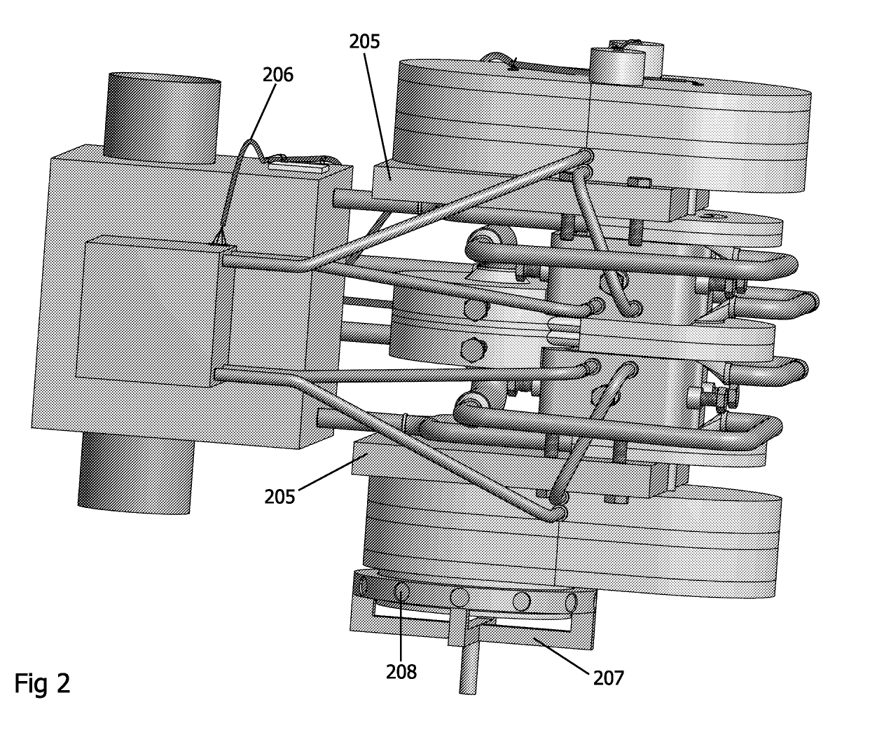

FIG. 2 is a custom angled view, with only the steel frame absent

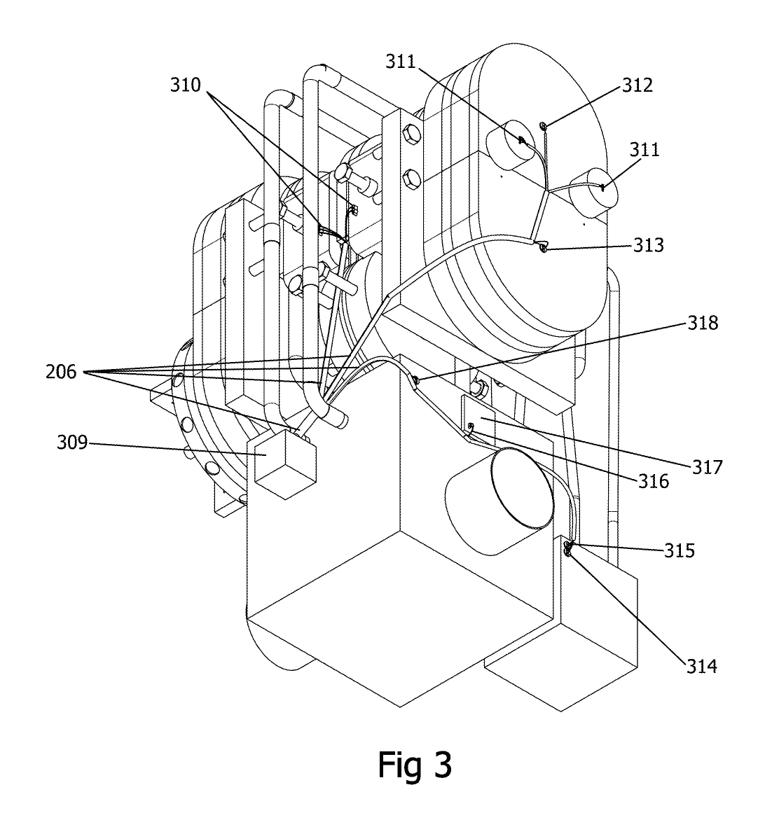

FIG. 3 is a view showing all electrical conduits and electrical contact points except for a Gauss sensor hidden in this view

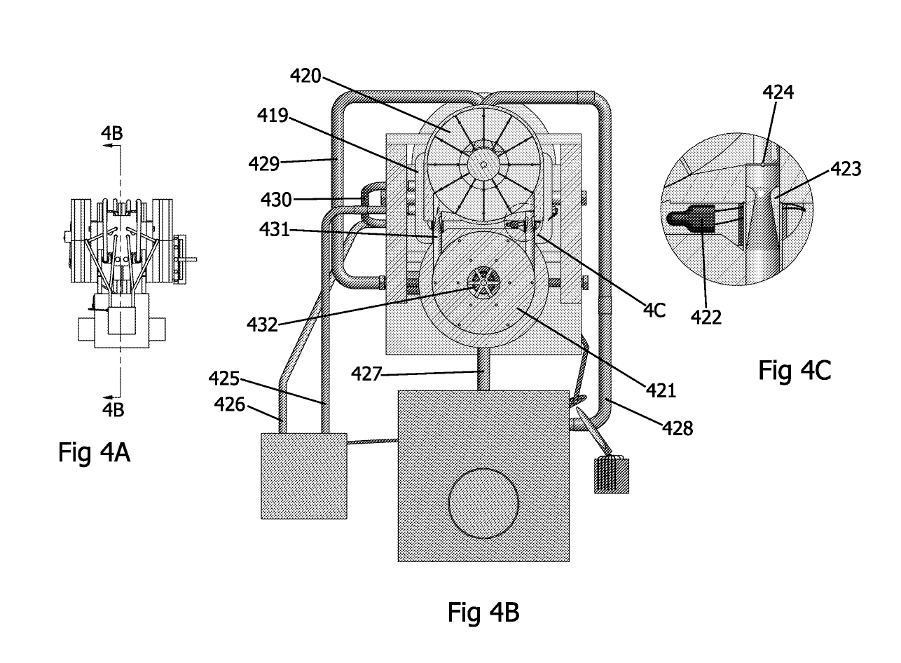

FIG. 4A shows where the cross-section for FIG. 4B was taken at

FIG. 4B is a view to show a cross-section of the turbine, high velocity pathways, and large heat wheel; and an encircling of the detail view for FIG. 4C

FIG. 4C shows a control valve for one of the four high velocity nozzles, a high velocity nozzle, and the Gauss sensor that was hidden in FIG. 3

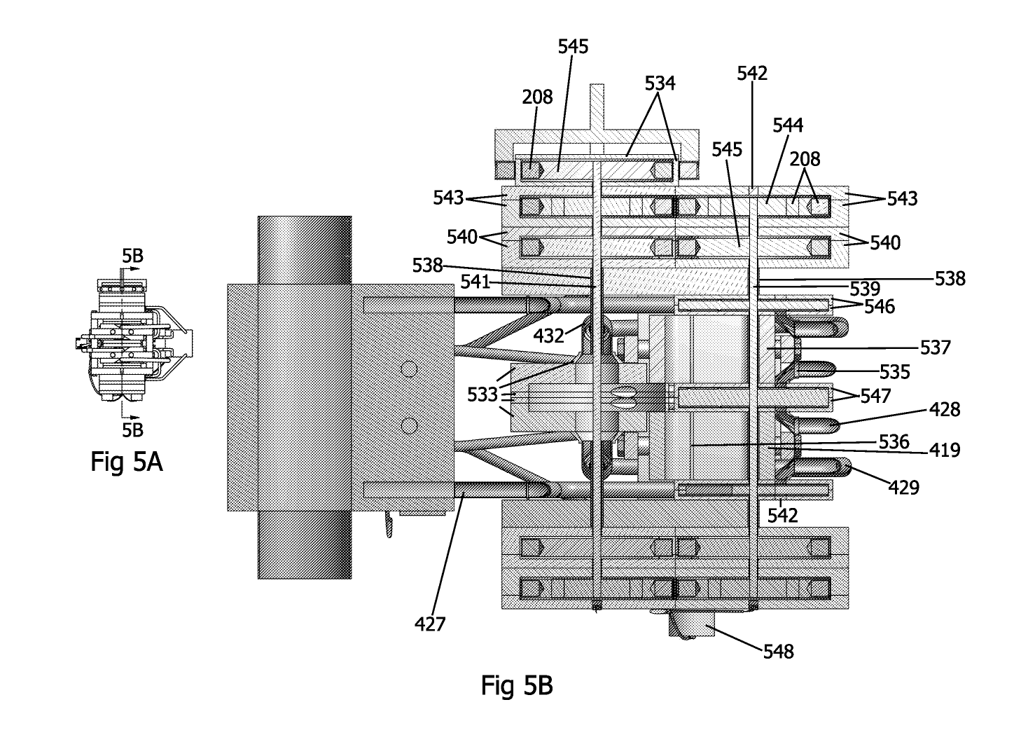

FIG. 5A shows where the cross-section for FIG. 5B was taken at

FIG. 5B is a view to show a cross-section through the main parts of the embodiment

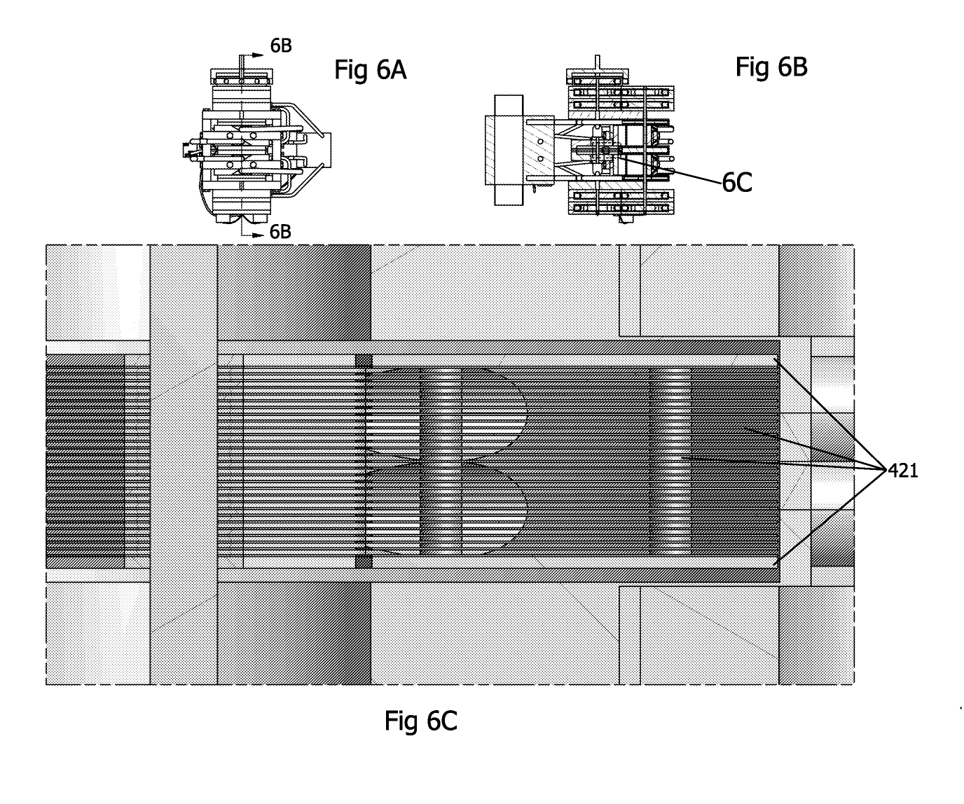

FIG. 6 shows where the cross-section for FIG. 6B was taken at

FIG. 6B is a cross-section view to show the rectangular detail view of FIG. 6C

FIG. 6C shows the turbine that would appear black in any view other than a detailed view since its turbine blades are so close together.

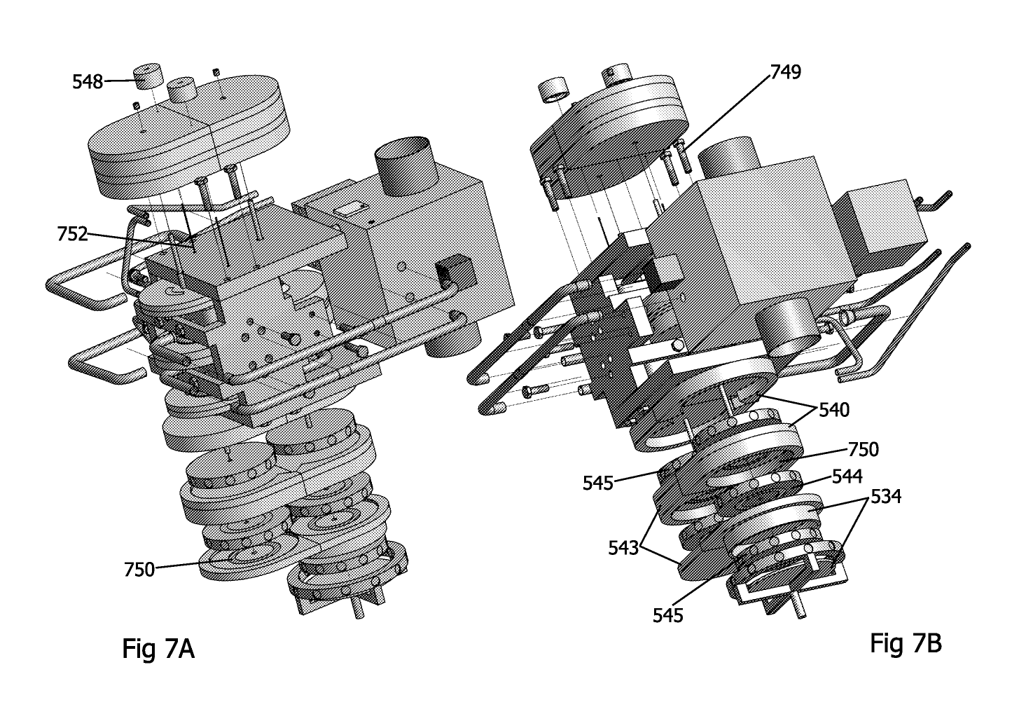

FIG. 7A shows an exploded view of the outer components of the embodiment at an angle to reveal bottom-sided features in addition to the outer components

FIG. 7B shows an exploded view of the outer components of the embodiment at an angle to reveal top-sided features in addition to the outer components

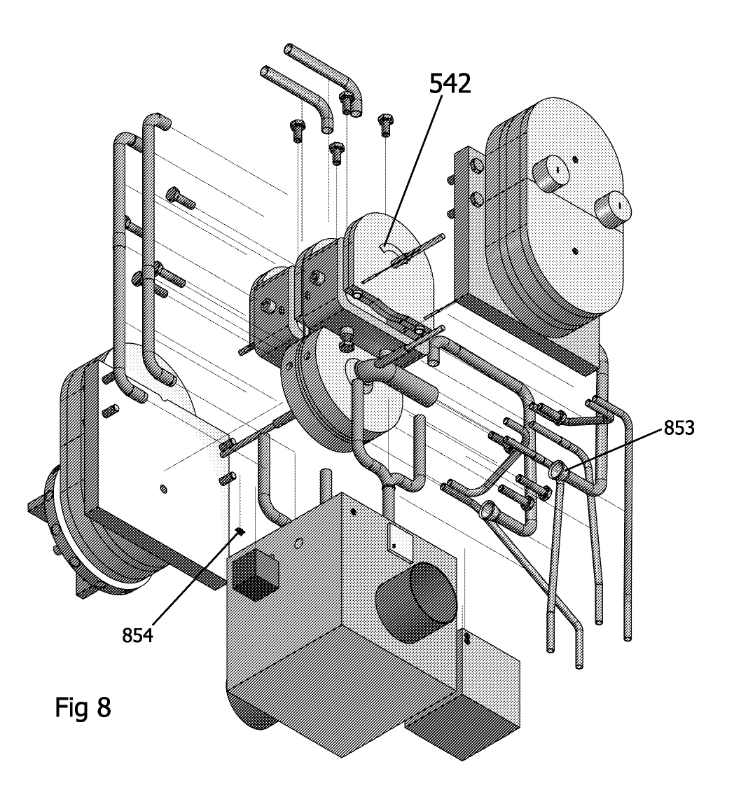

FIG. 8 shows the inner components in a together form with the outer components exploded far away so that the inner components can closely be inspected in assembled form

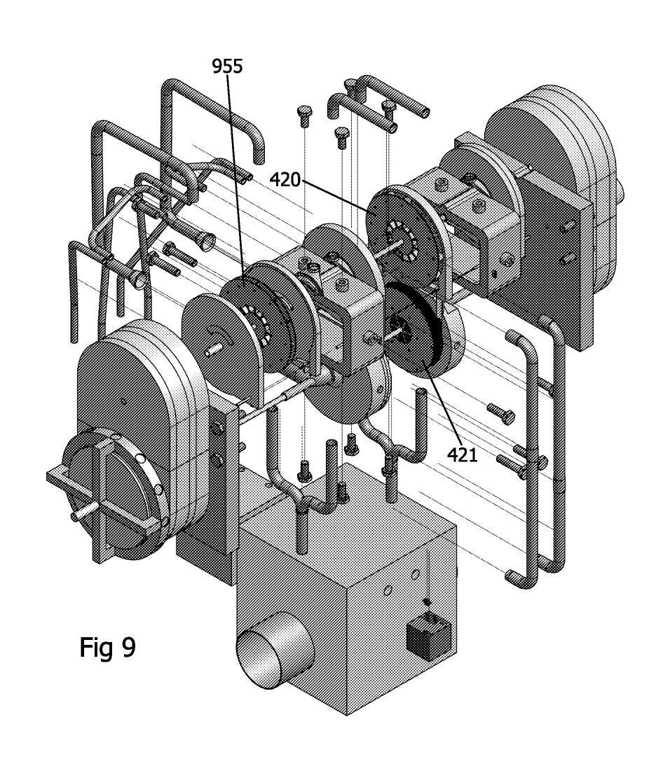

FIG. 9 shows the inner components exploded while the outer components are kept together far away so that the inner components can be closely inspected

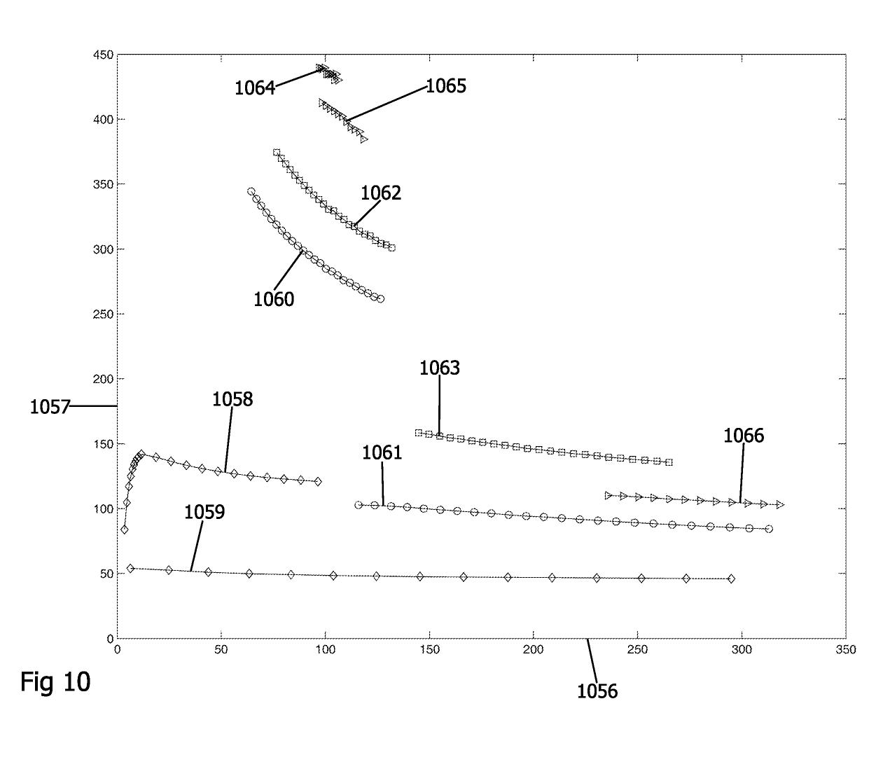

FIG. 10 is a working internal atmosphere chart with the y-axis representing the change in pressure in psi per degree kelvin of temperature change, 1057, and the x-axis representing the temperature at which the pressure change occurs, 1056.

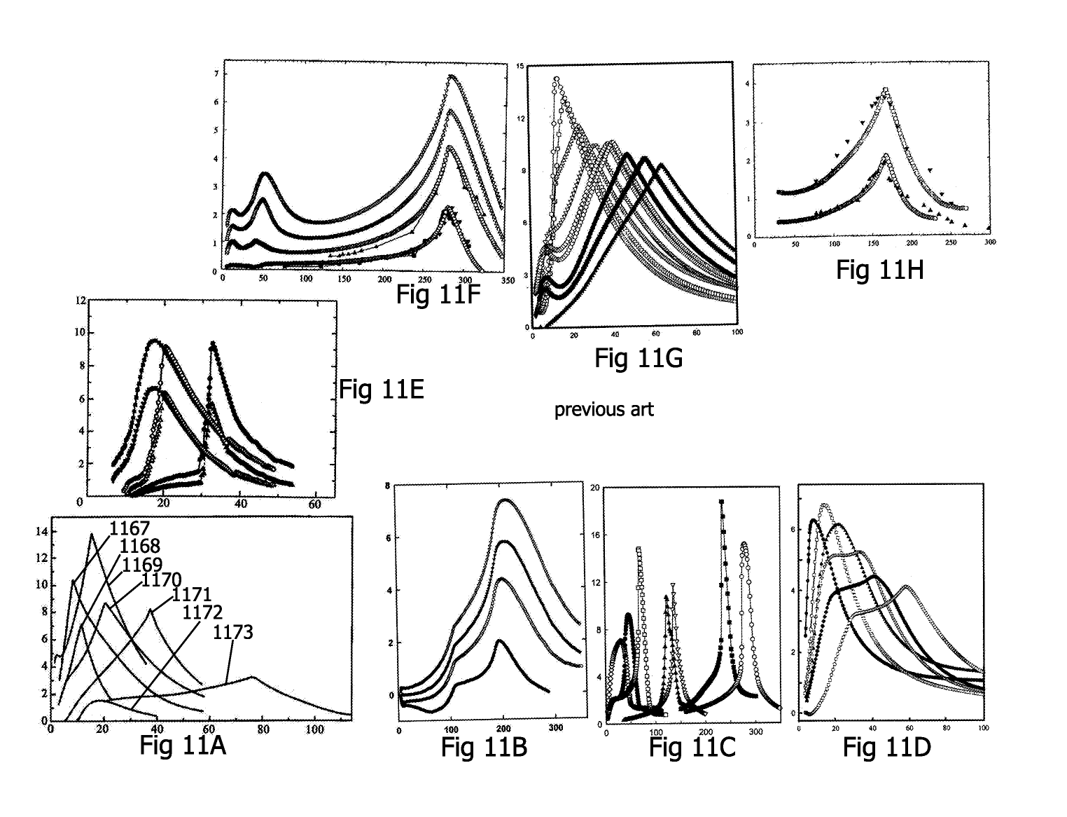

FIG. 11A through FIG. 11H represent the magnetocaloric effect in chart form, with each figure representing a certain magnetocaloric material. All of the magnetocaloric effect curves show the change in temperature, kelvin, along the y-axis at a constant magnetic field strength; and shows the temperature for which the change occurs along the x-axis

FIG. 11A shows curves at 5 Tesla for different materials in the form of RNi₂, where R stands for a rare earth metal atom

FIG. 11B through FIG. 11H show two types of charts shown with each type of chart having a series of characteristic curves for the material the chart represents, except for FIG. 11E which contains both types. One type of chart shows curves for the magnetocaloric effect of a material at different magnetic field strengths. The other type of chart shows curves for a magnetocaloric effect of a material at different compositions of that material, such as at differing amounts of X for the material Gd₅(Si_{X}Ge_{1-X})₄. Charts with different compositions show curves displaced along the x-axis; while charts with different magnetic field strengths show curves displaced along the y-axis. All curves are between 2 Tesla and 10 Tesla. Some charts may show curves that are mostly on top of each other; these curves are pulsed values of the same curve and are nearly identical to their respective curves.

FIG. 11B charts Gd₂In at 2 to 10 Tesla

FIG. 11C charts Gd₅(Si_{X}Ge_{1-X})₄ at 5 Tesla with X at the left curve being 0 and at the right curve being 0.5

FIG. 11D charts (Gd_{1-X}Er_{X})NiAl at 5 Tesla with X at the left curve being 1 and at the right curve being 0

FIG. 11E charts Er(Co_{1-X}Ni_{X})₂ at 3 and 5 Tesla with X at the left curve being 1 and at the right curve being 0

FIG. 11F charts Gd₃Al₂ at 2 to 10 Tesla

FIG. 11G charts (Dy_{1-X}Er_{X})Al₂ at 7.5 Tesla with X at the left curve being 1 and at the right curve being 0

FIG. 11H charts GdAl₂ at 2 and 5 Tesla

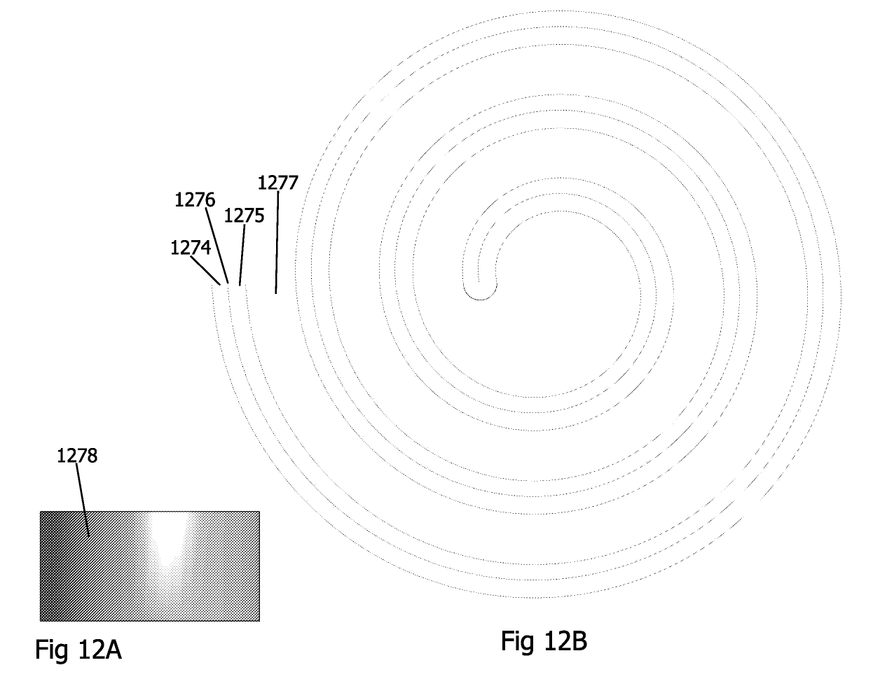

FIG. 12A is a side view of the width and height of a very basic spiral heat exchanger

FIG. 12B is a top view of FIG. 12A of the width and length of a very basic spiral heat exchanger

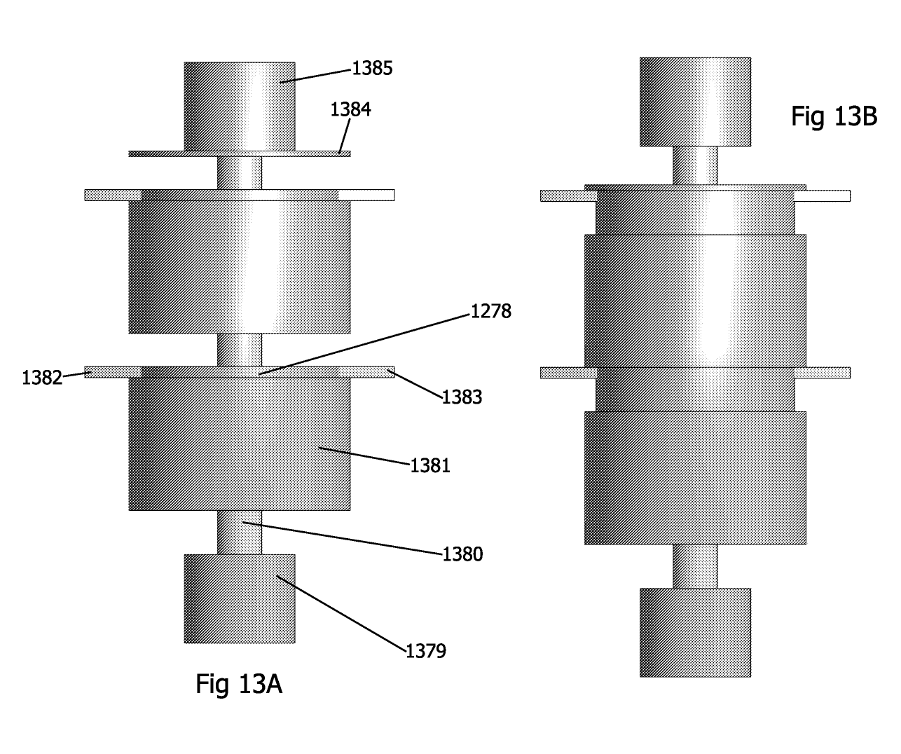

FIG. 13A is an anti-freeze based heat exchanger assembly with anti-freeze bath vats in the raised position

FIG. 13B is an anti-freeze based heat exchanger assembly with anti-freeze bath vats in the lowered position

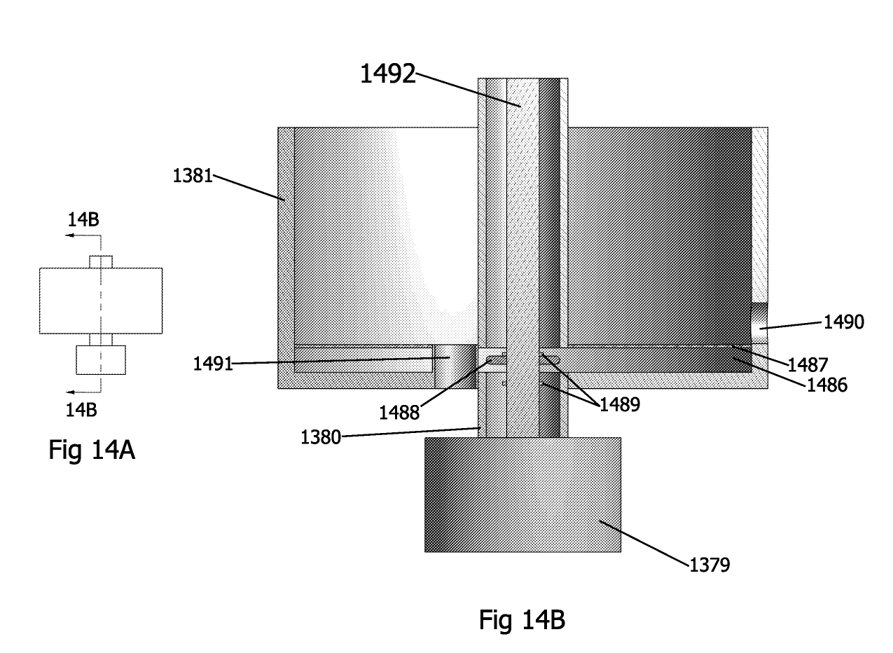

FIG. 14 is a section view of the bottom half of FIG. 13A or 13B, without a heat exchanger

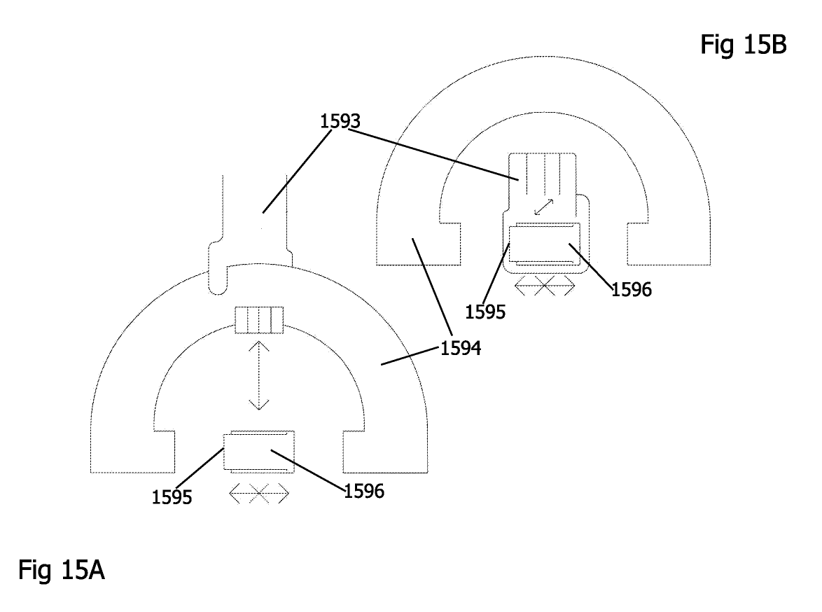

FIG. 15A is a front view of the second embodiment which is the most simplified embodiment in this invention

FIG. 15B is a front view of the second embodiment which is the most simplified embodiment in this invention

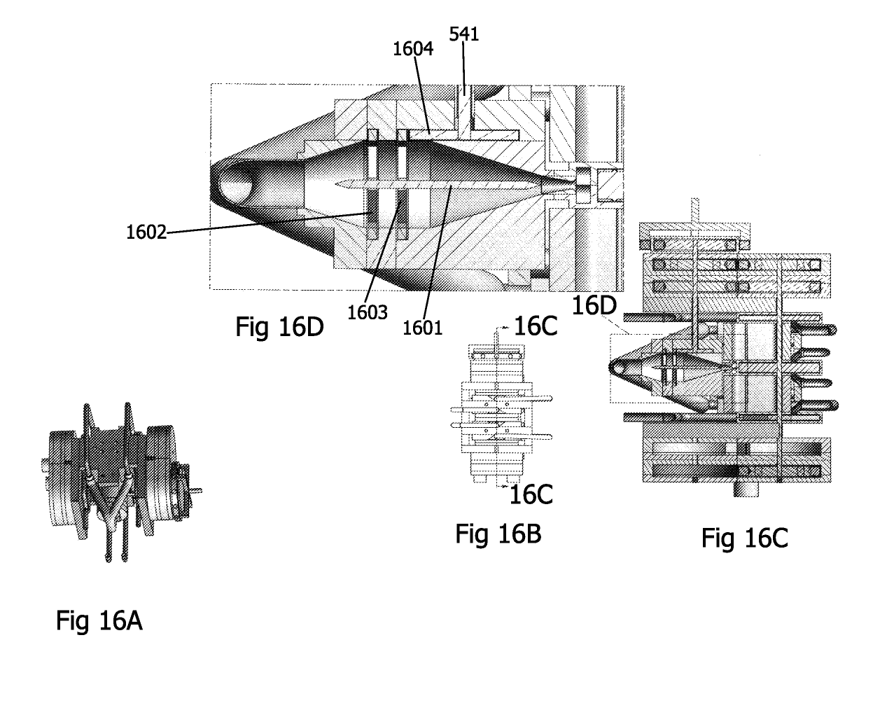

FIG. 16A is an angled view of the third embodiment which is just like the first embodiment with the exception being that the turbine is an axial flow turbine instead of the tangential flow type in the first embodiment.

FIG. 16B is for illustration of the sectioned view taken

FIG. 16C is a sectioned view from FIG. 16B showing a slice throughout the engine including the axial flow turbine spindle

FIG. 16D is a detailed view taken from FIG. 16C showing the components of the axial flow turbine spindle and the axial flow turbine spindle's linkage to the rest of the engine

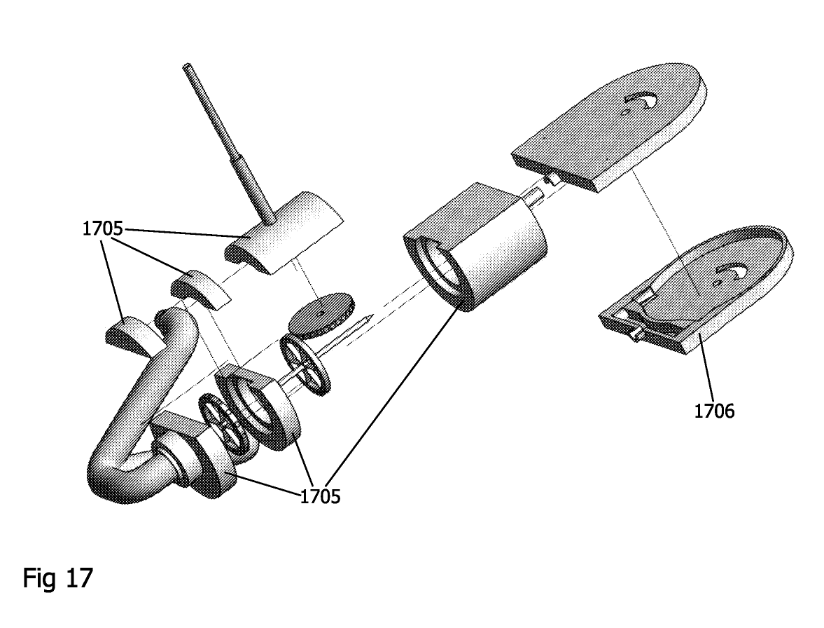

FIG. 17 is an exploded angled view of the top of the axial flow turbine spindle with adjacent components included

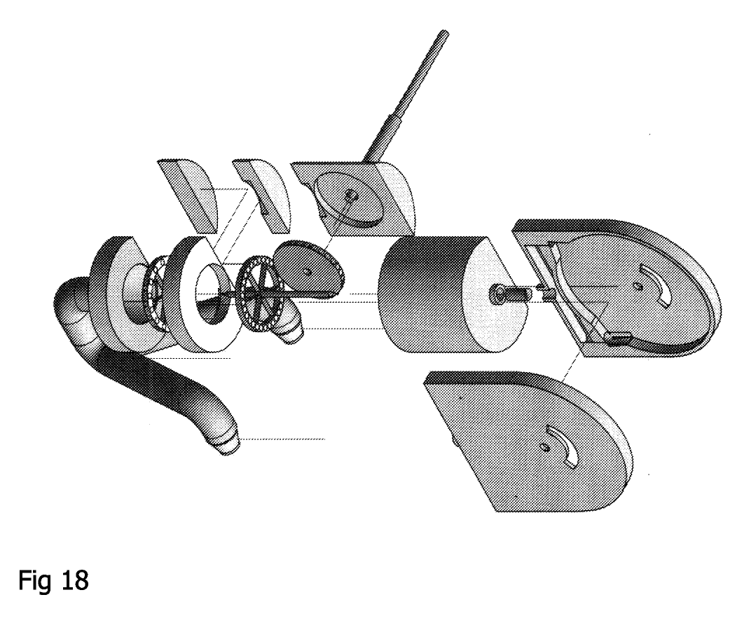

FIG. 18 is an exploded angled view of the bottom of the axial flow turbine spindle with adjacent components included

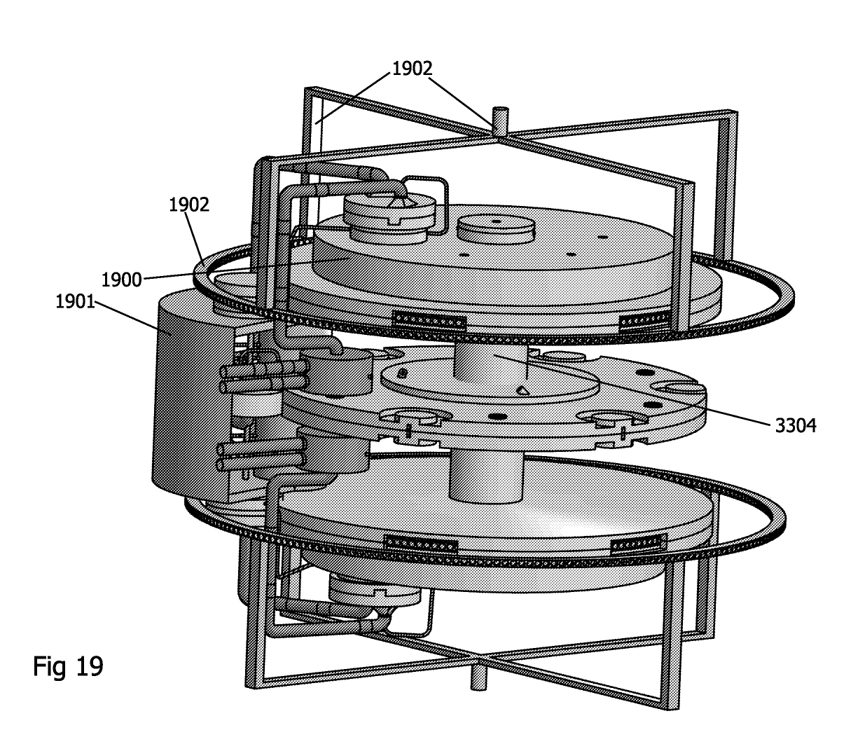

FIG. 19 is a view of the fourth embodiment with only the components of a single turbine made visible

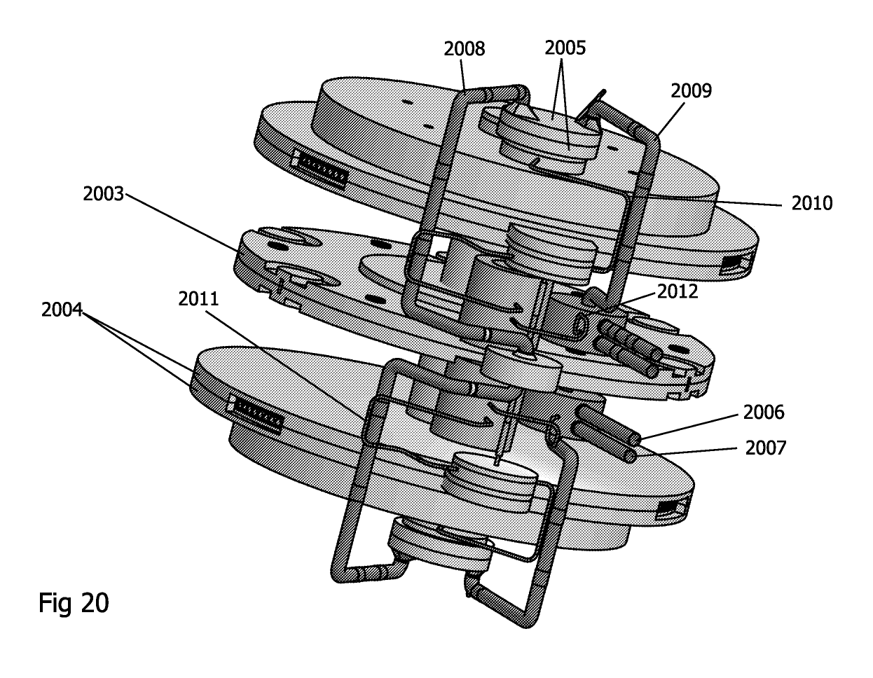

FIG. 20 is a view labeling most of the pipes

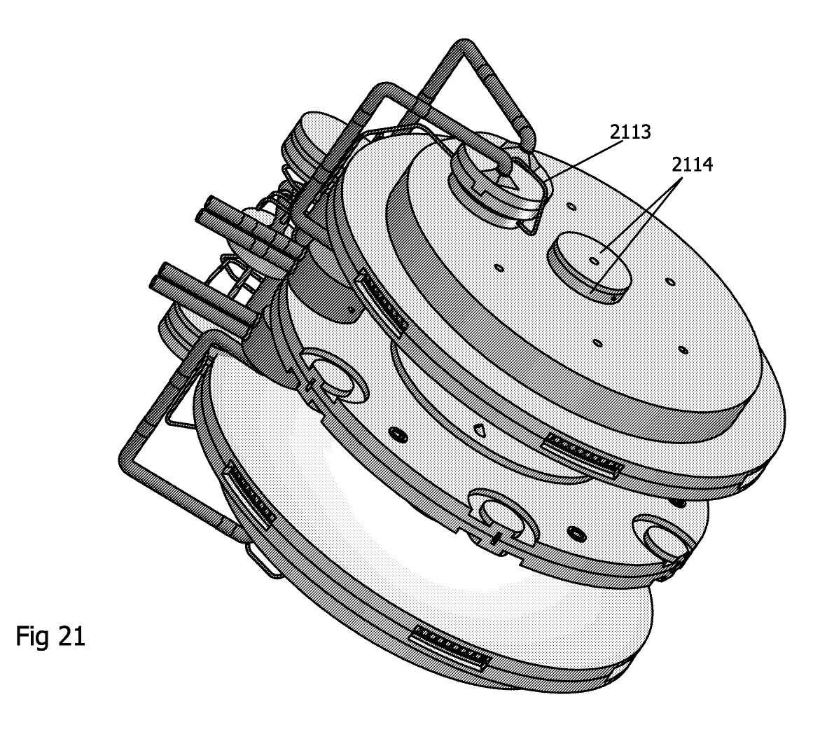

FIG. 21 is a back view showing the pump exhaust to magnetic bearing housing B coolant pipe

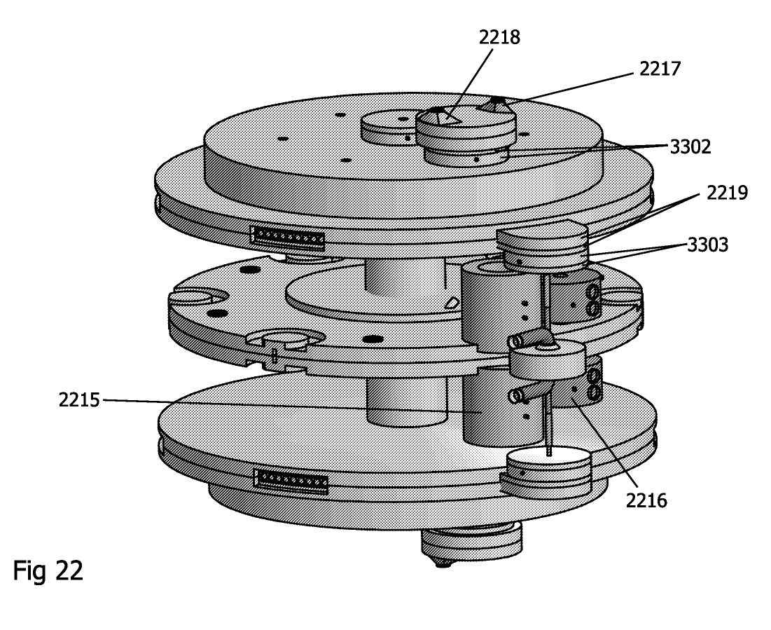

FIG. 22 is an angled view of various components

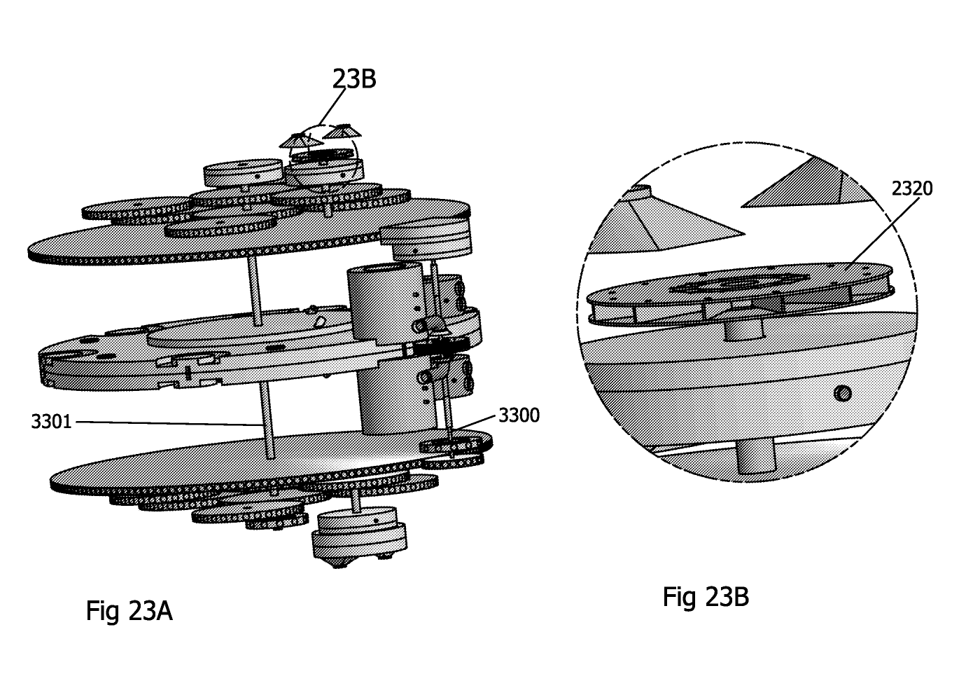

FIG. 23A is a view showing where a centrifugal pump is detailed

FIG. 23B is a detailed view of a centrifugal pump

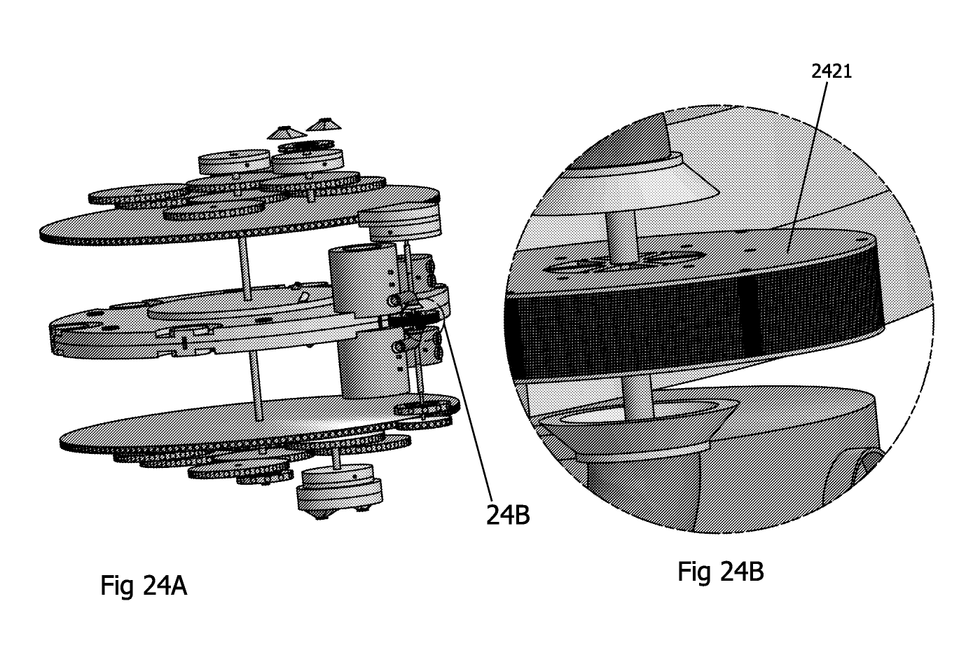

FIG. 24A is a view showing where a turbine is detailed

FIG. 24B is a detailed view of a turbine

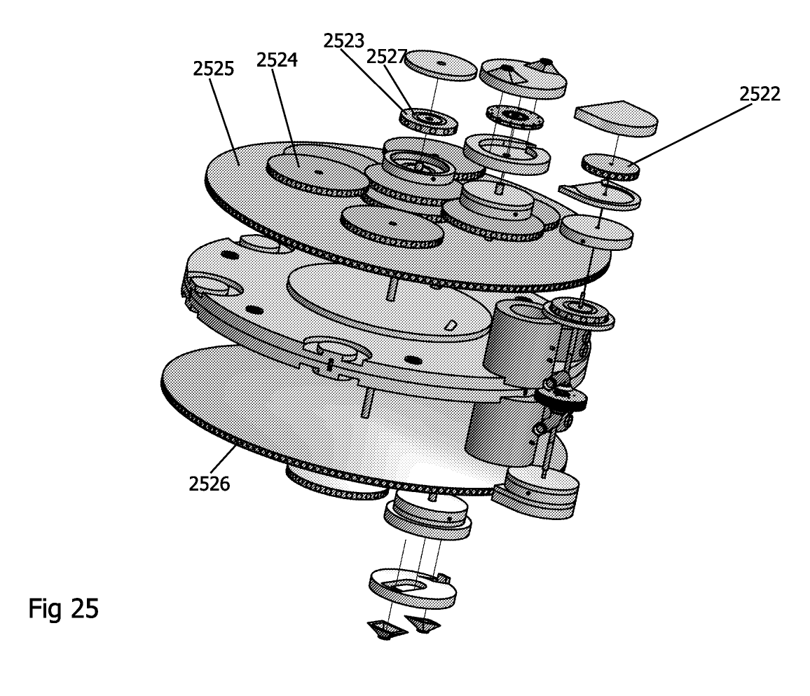

FIG. 25 is a view showing the upper components

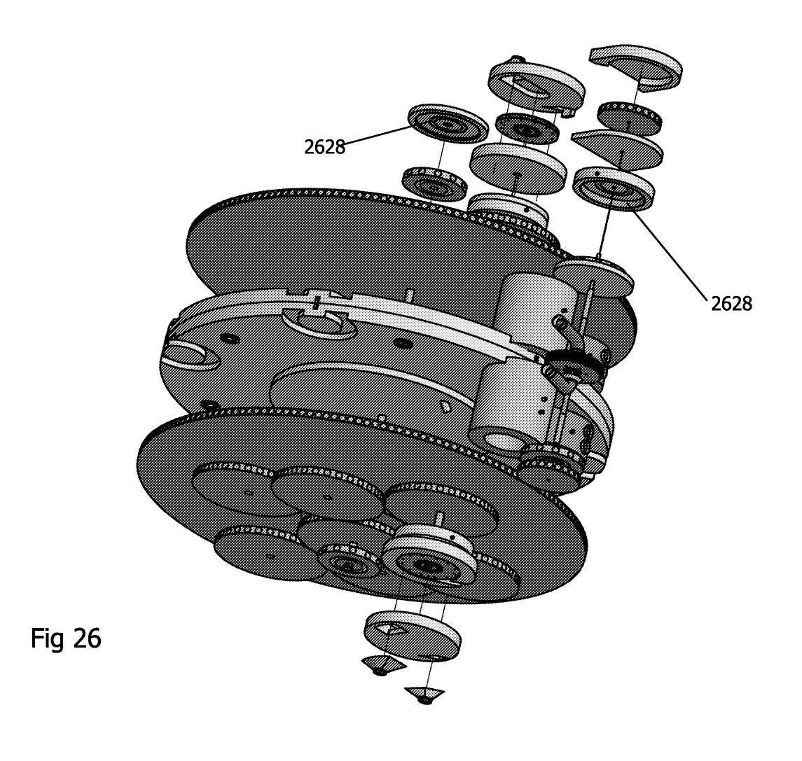

FIG. 26 is a bottom angled view showing the superconductors inside a magnetic bearing housing

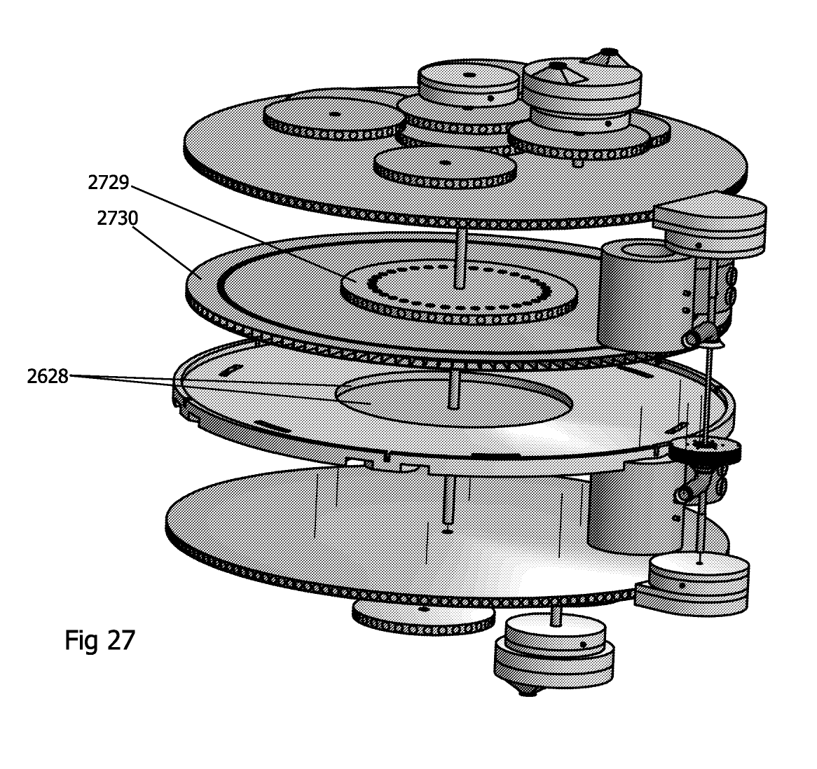

FIG. 27 is a view showing the heat wheel and components

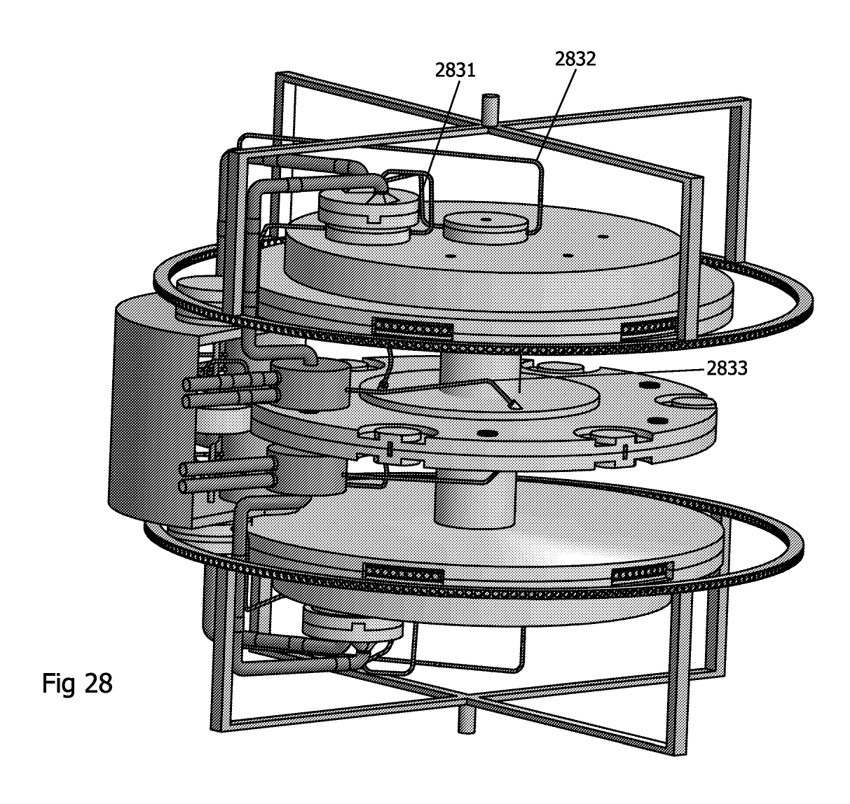

FIG. 28 is a view showing coolant pipes

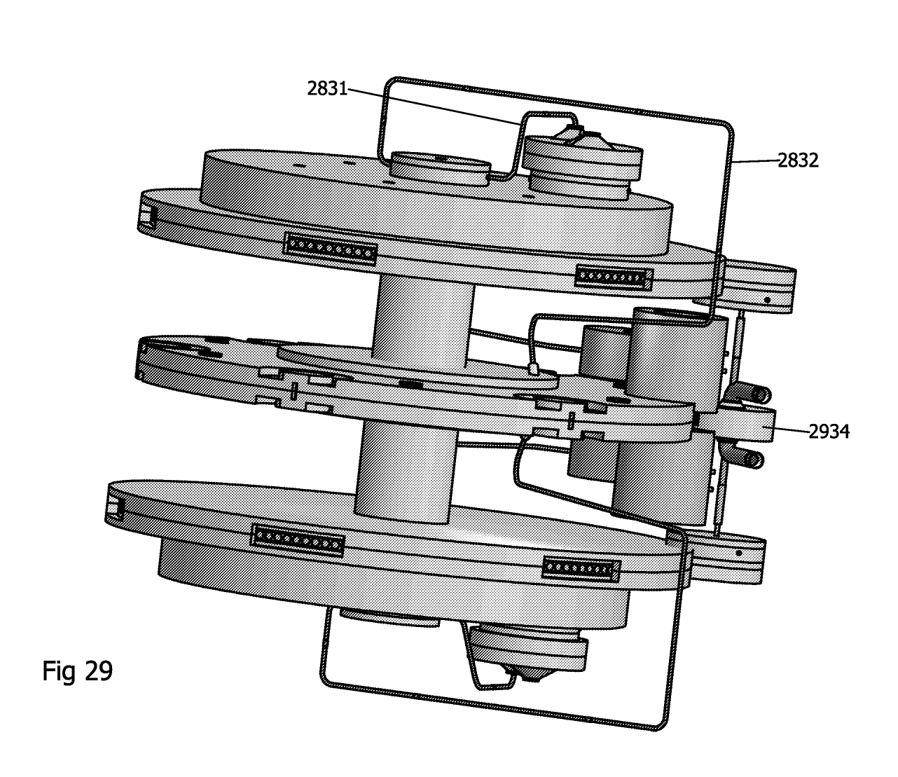

FIG. 29 is a back view showing the coolant pipes and turbine

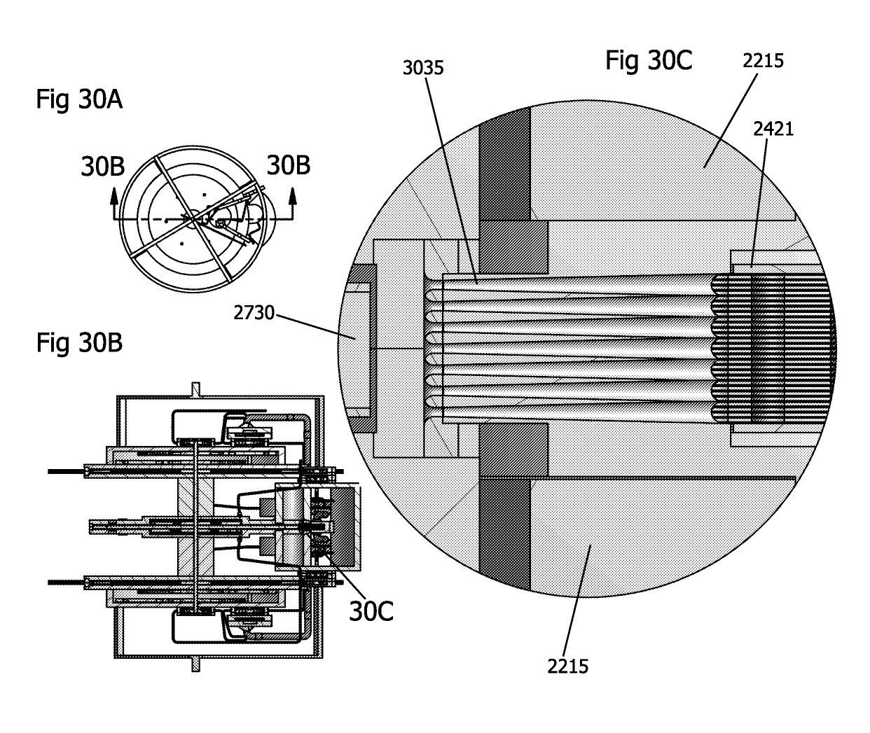

FIG. 30A is a view showing where a cross-section is taken at

FIG. 30B is a cross-section showing where a detailed view is taken at

FIG. 30C is a detailed view of the edge of the heat wheel, the supersonic velocity nozzles, and the turbine

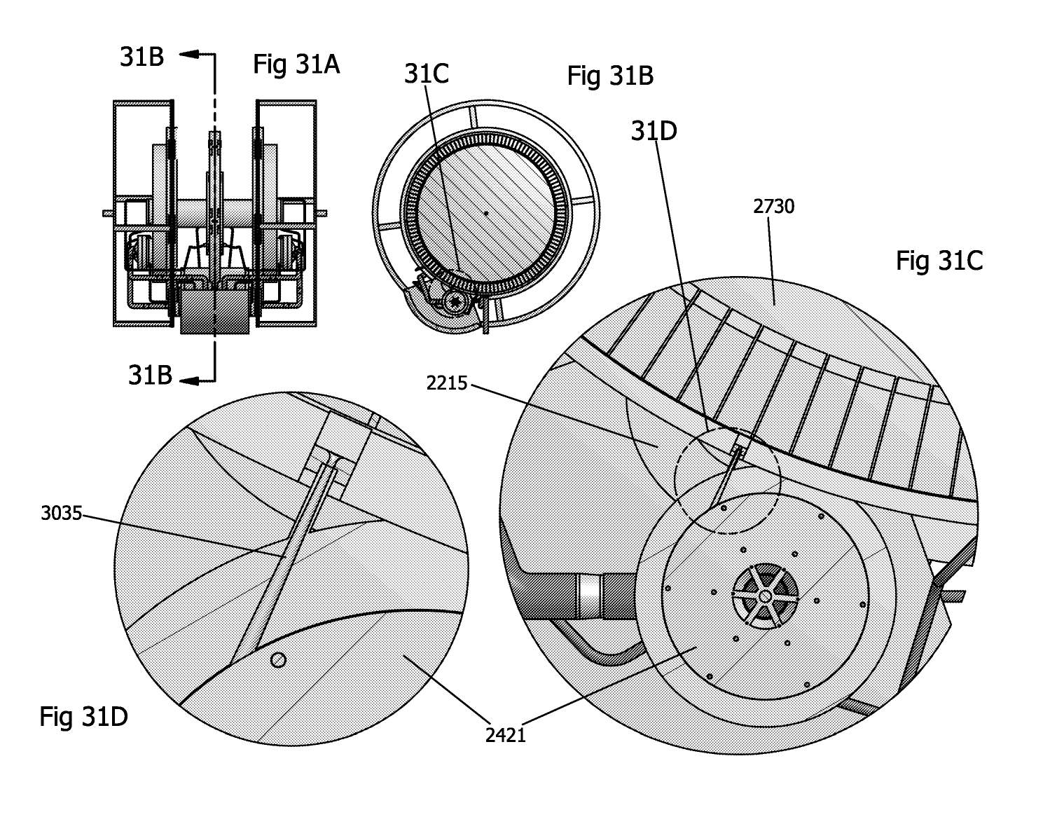

FIG. 31A is a view showing where a cross-section is taken at

FIG. 31B is a cross-section showing where a detailed view is taken at FIG. 31C is a detailed view showing where another detailed view is taken at

FIG. 31D is a detailed view showing the supersonic velocity nozzle and adjacent components

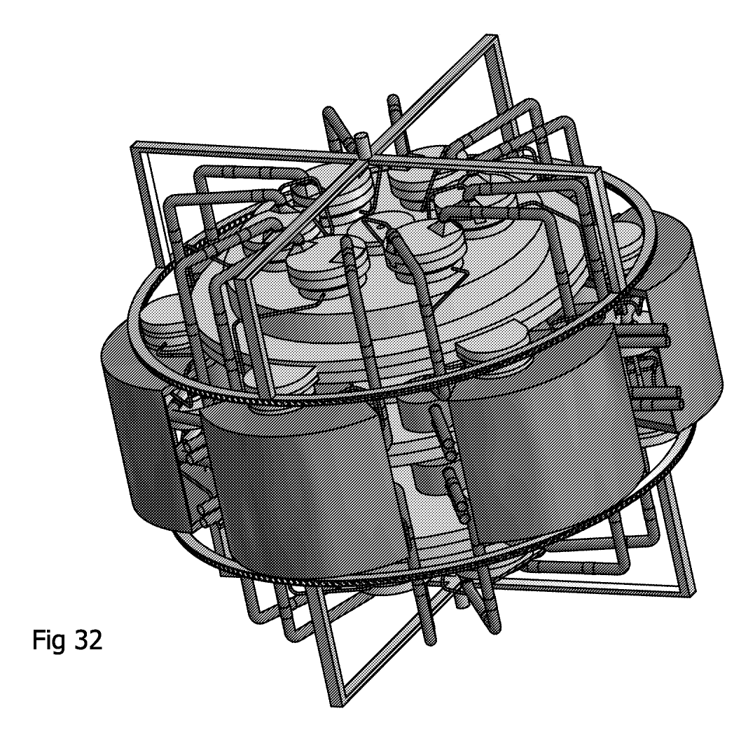

FIG. 32 is a view where all turbines of the embodiment are visible, along with their components, and the only thing not visible are the central coolant pipes

### DETAILED DESCRIPTION

### First Embodiment

All reference numerals have the first digit or first two digits referencing the figure and the patent drawing sheet upon which the figure appears first starting with FIG. 1 and ending with FIG. 32. The only exception are numerals in the 33XX series.

The embodiment herein covers any engine size from roughly the smallest to roughly the largest and can generally be applied to turn any other type of engine into one of this type by turning another engine into an engine that runs off the same principles as this embodiment describes, as will be explained in the operation section. Any calculations unless otherwise specified refer to a generic model of this embodiment that is targeted at the most produced engine of all, the vehicular engine; and, this model's calculations use an engine of 400 horsepower, 300 kilowatts, and 40% turbine efficiency to yield an actual drive-shaft power of 160 horsepower equal to 120 kilowatts, 120 Joules/second.

The steel frame, 101, holds the engine structurally together. Nearly all parts will be welded together to keep the pressurized atmosphere within the engine; however a bolted gasket configuration can also work to keep the engine pressurized. Yet, for inside atmospheres like helium instead of ethane, a welded configuration will help retain the helium from leaking through the engine by way of the gaskets. Nitrogen is another possible atmosphere due to its ability to remain a gas at very cold temperatures and due to Nitrogen having a small change in temperature that results in a large change in pressure at higher densities as a gas, which is also a needed feature of other gases if they are to be used in the embodiment. The most important feature for increased power is a large temperature difference between melting and boiling points of the fluid. This large difference allows more heat energy to be extracted. Other gases may be used, but to maximize heat extraction from the external environment, only gases at very cold temperatures can be used. This gas and temperature restriction leaves the three aforementioned gasses as the optimal choices. However, warmer gases my be used, especially for smaller engines, or engines operating at higher heat exchanger temperatures, or engines operating at near-room temperature as refrigerators.

There is a heat exchanger, 102. There are two external forced convection coverable ducts, 104. The steel frame, 101, has four bolt holes on each of 6 faces. The bolt holes on the top and bottom face match with those on steel end-plates, 205. In FIG. 1, the bolt holes on the right side and left side of steel frame, 101, match with those found in FIG. 5B on the sides of super-conducting magnet assembly A, 419, and super-conducting magnet assembly B, 537. On each end of a super-conducting magnet is another bolt hole that bolts to the steel frame, 101. The four remaining bolt holes bolt two through the front and two through the back of the steel frame, 101, and into the turbine housing, 533. The bolts, 749, are the same size but differ a small amount in length and were drawn as size M24, but only need to be large enough to withstand the large magnetic forces produced by both super-conducting magnets. The steel frame, 101, is not present in any figures, where the middle is the object of interest, where the steel frame, 101, would otherwise block the view.

Permanent magnets, 208, and the external coupling drive-shaft, 207, provide the connection between the engine and whatever it is to be externally coupled too. The external coupling is magnetic and on the engine side the coupling takes place from within the external coupling housing, 534. There are five coupling disks, 545 throughout the engine. Four coupling disks, 545, are placed symmetrically, like the rest of the engine which has a highly symmetrical design. The coupling disk, 545, placed non-symmetrically is used for external coupling to the external coupling drive-shaft, 207. The coupling disk, 545, has permanent magnets, 208, arranged with their north and south faces alternatingly directed outward and used for magnetic coupling.

The other four coupling disks, 545, are used as magnetic gears to keep the axle on the heat wheel side, 539, and the axle on the turbine side, 541, moving at rates in unison. The axle on the heat wheel side, 539, does not have to be located within the superconducting magnet assemblies.

Heat wheel inner compartments make a ring in shape and having larger diameter rings will increase allowable heat wheel RPM speed. Having heat wheels with diameters that are almost as large as a car is long substantially increase power output and would be suited for an industrial setting where size is not a concern.

The four coupling disks, 545, are used for internal coupling, with each disk within an internal coupling housing, 540. These magnetic gears will function even better with more permanent magnets, 208, along the circumference of the coupling disks, 545, but price will also be increased. Square permanent magnets may also be used in the coupling disks, 545, but holes for round permanent magnets are easier to machine. Each internal coupling housing is open on one side so that when an internal coupling disk is coupled to another internal coupling disk, no material separates them. If the housings are made of a low permeability material like aluminum, having material in-between the internal coupling disks will not affect operation; hence, material may be left between in this case.

Close to the end of each axle is a superconductive and magnetic bearing housing, 543. Since this bearing operates on the principle of magnetic levitation above superconductors, there are superconductors on all interior faces of the superconductive and magnetic bearing housing, 543. In FIGS. 7A and 7B, the top and side superconductor, 750, is referenced respectively. In FIG. 2 there are coolant holes in the superconductive and magnetic bearing housing, 543, for coolant to be pumped within the walls of the housing to cool low temperature superconductors, unless coolant is not needed which is the case for higher temperature superconductors and colder working atmospheres like ethane, nitrogen, or helium. Also, other bearings may be used but are less optimal when working with a powder of specific size.

Inside each superconductive and magnetic bearing housing, 543, is a bearing disk, 544. The only difference between a bearing disk, 544, and a coupling disk, 545, is a ring permanent magnet, 208, added to the middle of the bearing disk, 544, as seen in FIG. 5B. This ring permanent magnet, although the same type, is different in structure than the first permanent magnet referenced and can be seen more clearly in perspective in FIG. 7A. All of the permanent magnets, 208, are magnetized so that their top and bottom faces are the poles.

The exterior structure of the superconducting magnets, along with the steel frame, 101, and steel end-plates, 205, make the bolted together framework that the rest of the engine is welded together to. In FIG. 5B, the steel end-plates, 205, provide structure for the internal coupling housings, 540, and on top of them, the superconductive & magnetic bearing housings, 543, to be mounted upon. The steel end-plates, 205, also sandwich the small heat wheel housings, 546, the super-conducting magnet assemblies, 537 & 419, and the large heat wheel housing, 547, together tightly.

In FIG. 5B, the large heat wheel housing, 547, is between the two superconducting magnets, 537 & 419. On the other ends of the superconducting magnets are the small heat wheel housings, 546. The large heat wheel housing, 547, is connected to the turbine housing, 533, by way of the large heat wheel to turbine high velocity passageways, 431. Within the passageways are the high velocity nozzles, 423. There are four high velocity passageways directed at the turbine with two on each half of the Large heat wheel, 420. The small heat wheels, 955, only have one passage way on each side, but they are not high velocity since they lack a nozzle; although the inner atmosphere can approach fairly high velocities in these passageways as engine produces higher pressures. All passageways can be closed or opened by way of forward & reverse valves, 424, that control if the external coupling ends up spinning forward, reverse, or off in the case that the valves on both sides of the heat wheels are blocking the passageways. These valves can also be partially closed to reduce engine power. The valves vertically above one and another on each half of the machine are connected through a valve shaft conduit, 536, and together by the valve shaft, 752, which extends through one of the steel end-plates, 205, through the bearing and internal coupling housings, and to the geared stepper motor with housing and positional encoder, 548.

The turbine, 421, is only shown in two views, FIG. 4B and FIG. 6C because any other view would make the turbine appear black due to its many very thin disks making many black lines too closely spaced to be capable of visualizing. The generic turbine, 421, depicted is a boundary layer effect type turbine, but the turbine can vary greatly in type. The embodiment allows virtually any type of turbine setup since the embodiment can operate between about 50 and 5,000 psi, and at virtually any rpm speed due to the type of gears and the type of bearings of the embodiment. The actual operating pressure of the turbine depends upon the type of magneto-caloric material, the internal working atmosphere, and the strength of the magnetic field within the large heat wheel housing, 547. Any turbine that is compact, efficient, powerful, and reversible is suitable, however reversibility is not mandatory if the particular intended use of the embodiment does not require reversibility. Compactness and power are very important and efficiency is less important; since, even the energy not converted due to inefficiency is still bound within the engine and will eventually be converted to useable energy. This is because energy not converted will remain as heat at a lower temperature than ambient surroundings and hence will stay within the engine by thermodynamical laws until the heat will eventually be converted into useable energy as the heat re-loops through the engine.

If the engine is only needed to spin one way, which is the case if outside gears take care of a reverse feature if needed, or which is can be the case if no external coupling is used when functioning as a refrigerator, or which is the case if only forward spinning is needed, then the machine can be simplified by not including the passageways, piping, valves, nozzles, and motor controls for reverse operation.

In the case that no external coupling is used as can be the case with a refrigerator, an electrical generator can be placed within the external coupling housing, 534, to change the heat energy extracted into electrical energy so that the energy can be transported outside and away from whatever is being refrigerated.

The electrical conduit, 206, guides the wires from the electronic controls unit, 309, to sensors and input/output hardware. The electronic controls unit, 309, contains the electronic processing hardware and input/output hardware to operate and maintain the embodiment in proper working order. The electrical conduit, 206, connects to the resistive passive switch heater & charging input, 310, of the superconducting magnet assemblies. Also connected, is the motive input & positional encoder output, 311, for the stepper motors controlling the position of the forward and reverse valves. Also connected, is the pressure sensor, 312, and the temperature sensor, 313. Also connected, is the heat exchanger serial communication port, 318. Also connected, is the thermocouple, 317, and the temperature sensor leads, 316. Also connected, are the electrical power output terminal, 314, and the refrigeration serial communication port, 315. Last connected, is the Gauss sensor, 422. The electronic controls unit, 309, is equipped with a user interface connector, 854. The electronic controls unit is powered from the electrical power output terminal, 314. If the refrigeration device, 103, is either not present or not used to power the electronic controls unit, 309, the electronic controls unit could alternatively be powered from a thermocouple like the thermocouple, 317, or through an externally or internally coupled alternator.

The super-conducting magnet assemblies, 419 & 537, mirror each other vertically. The superconducting material can be a low temperature superconductor, which will need separate refrigeration if anything other than an internal atmosphere of helium is used. To provide refrigeration, there is one pipe fitting for coolant entering and one pipe fitting for coolant exiting on each superconducting magnet assembly as seen in FIG. 2. If an internal atmosphere of helium is being used in the engine and the engine is operating within the required temperature range for low temperature super-conduction, the engine can cool its own superconductors by routing the piping between the small heat wheels and the heat exchanger to instead go through the sections requiring superconductive cooling, and then through the heat exchanger.

A permanent magnet could be used in place of a super-conducting magnet assembly, but the power output will be roughly an order of magnitude less or lower due to the lower magnetic field of a permanent magnet.

Super-conductive magnets could be made to replace permanent magnets, but this would unnecessarily complicate the engine, with the only gain being that the engine's operating life would be farther than the life of the permanent magnets, which is already around the magnitude of more than a century. However, this might be important in satellites or future technology. The modifications needed would be that each axle would gain electricity through induction at a voltage potential for use by charging circuitry; that the charging circuitry would be used to keep the superconductors charged, replacing the permanent magnets that are attached around the axles.

The super-conducting magnet assemblies, 419 & 537, have an insulative shell around the superconductors to lower the cooling requirements of the superconductors. For the superconductors inside the superconductive and magnetic bearing housing, 543, this insulative shell can be a film on the internal engine side. The coolant chamber that is cooling the superconductors in the superconductive and magnetic bearing housing, 543, should be insulated except where the chamber contacts the superconductors.

The whole engine should be insulated with a high grade insulator, for example Aerogel or a suitable alternative, so that the engine can maintain its internal temperature and energy when powered down. This shell can also go between the external coupling drive-shaft, 207, and the rest of the engine since there is some spacing between them. Otherwise, any energy leaking in will have to be extracted by the engine to maintain homeostasis when powered down. This means that the energy entering, when the engine is powered down, will have to be displaced outside of the engine compartment by the engine as energy in the form of kinetic or potential energy through Joule heating or another suitable method. Since some energy will leak in no matter how well insulated the engine is, external energy displacement is a feature that is needed for any engine that needs a power down feature. Otherwise, the engine would overheat when off and raise the internal atmospheric temperature to a point that makes the engine no longer work properly until the engine is cooled, by external method, to a low enough temperature to be operational again. If the engine does not need a power down feature, then the engine does not need outer insulation.

If the engine needs to be able to operate at higher temperatures, like at room temperature, down to superconductive temperatures, as for example how a scientific refrigerator needs to operate, then a tank and compressor can be connected to the engine's internal atmosphere such that the internal atmosphere's density can be lowered so that the engine's internal atmosphere stays a gas within optimal operating temperature ranges. This embodiment solves the issue of the engine needing to maintain a cold operating temperature, but other ways to solve this issue will also be mentioned. The tank and compressor could also be realized by an air displacement chamber and linear motive plunger with motor, or another suitable pressurization technology. There are magnetocaloric materials, such as Gd₃Al₂ in FIG. 11F, and internal atmospheres such as helium at 110 kg/m³, 1059, that can make such a scientific refrigerator possible. In addition, more than one type of magnetocaloric material can be used to increase the temperature range. If the density is increased by the aforementioned method, larger efficiencies are possible such as that by helium at 200 kg/m³, 1058. Of course, this scientific refrigerator is possible without a tank and compressor if helium at 110 kg/m³, 1059, is used, but the efficiency and power over the possible operating temperatures will be less as exemplified by the charts of helium at 110 kg/m³, 1059, and helium at 200 kg/m³, 1058. This high to low temperature scientific refrigerator can also be used as an alternative embodiment where deicing inside the heat exchanger is not a concern when the engine is powered down. Since the super-conductors still need to be cooled, a secondary engine would be needed for cooling.

Alternatively, a secondary engine is not needed if the scientific refrigerator in the previous example runs at its coldest temperatures and refrigerates to the right degree by using a heat exchanger, 102, and controls the cooling temperature by the flow rate of a heat exchanger fluid that can be liquid helium running in a secondary closed cooling loop through the heat exchanger, 102.

Homeostasis is needed if the engine is powered down. It is preferable for an engine not to have a powered down mode since a lack of a powered down mode simplifies the engine. The optimal embodiment will be an engine that will not need to operate at room temperature.

The engine in powered down mode will operate far below room temperature and maintain its homeostasis by operating the heat exchanger and an energy output device within temperature specifications.

Powered down mode can be analyzed as follows. If heat energy crossing the insulation is negligible, and heat energy entering the heat exchanger is negligible, energy within the engine compartment is a conserved system. Heat flow can be made negligible into the heat exchanger by covering the heat exchangers opening and closing forced convection cover-able ducts, 104, with an insulated cover. If the engine was completely shut off the temperature would be equalized. However if the engine was allowed to run just enough to maintain its internal temperature by releasing energy externally to some output device in the amount that is crossing into the engine, the engine will maintain homeostasis in powered down mode.

When the engine is running in regular mode, its internal temperature, and hence homeostasis, can be maintained by controlling the rate of heat flow through the heat exchanger. The rate of heat flow can be controlled by the rate of fuel flow in fueled heat exchangers or can be controlled by the external atmosphere, or fluid, flow rate through the heat exchanger in fuel-less heat exchangers.

The super-conducting magnet assemblies, 419 & 537, create magnetic fields that separate each heat wheel in half, except at the axle notch in each superconducting magnet assembly, which has a negligible effect due the fact the heat wheel's geometry does not permit the internal atmosphere to be near the heat wheel's center. The high velocity nozzles, 423, are also under the same field. The magnetic field, of the superconducting magnet assemblies, that permeates past the small heat wheels is shunted by the steel frame, 101, and steel end-plates, 205, so that the high strength magnetic field does not dangerously permeate out of the engine. Mu-metal may be used along the inside or outside of the steel frame, 101, and steel end-plates, 205, to increase the shunting of magnetic fields if the prior permeation is unacceptable. Moreover, the shape and location of the steel frame, 101, and steel end-plates, 205, and superconducting magnet assemblies help to shape the magnetic field to optimally pass through the hot side of the heat wheels. Furthermore, mu-metal shielding can be placed against the inside of the engine compartment for added shielding since layered shielding is more effective. An alternative metal to a steel frame and steel end-plates can also be used if mu-metal, or a suitable alternative, is used as previously mentioned.

FIG. 10 is vital in determining the pressure, in psi, produced within a small or large heat wheel, 955 or 420 respectively. If the temperature change of the magnetocaloric material in degrees is known, the psi can be determined by multiplying the magnitude of change in degrees by the y-axis value at the x-axis temperature that the change started at. The y-axis represents the change in pressure in psi per degree kelvin of temperature change, 1057, and the x-axis represents the temperature at which the pressure change occurs, 1056. The actual temperature change used is half of the magnetocaloric material's temperature change since only waiting for the internal atmosphere to absorb part, in example half, of the magnetocaloric material's temperature allows for a significant increase in rpm.

The shapes of the data markers used in the charts of FIG. 10 that are the same, for instance the circle data markers, represent the same type of internal atmosphere, nitrogen. Each atmosphere is at a constant gas density. Each chart for the same internal atmosphere type, marked by the same shape data marker, is at a different gas density.

In general for the gases charted, as the temperature decreases the gas becomes more efficient since the gas has a greater change in pressure for a degree change in temperature. The chart of helium at 200 kg/m³, 1058 shows a phase change at its beginning, the other charts do not. The other charts represent roughly the coldest temperature each gas can reach. The fluid density should be changed within the engine to change the temperature at which the gas has a phase change at. This adjusts the power able to be extracted from the engine from the gas phase up until the solid phase by widening the liquid phase.

The unspecified remaining charts are: nitrogen at 620 kg/m³, 1063, and nitrogen at 781 kg/m³, 1060, and ethane at 658 kg/m³, 1064, and ethane at 645, 1065, and a mixture of 40% ethane & 60% nitrogen at 760 kg/m³, 1062, and a mixture of 40% ethane & 60% nitrogen at 620 kg/m³, 1063.

In FIG. 11A, the magnetocaloric materials of the form of RNi₂, with R representing a rare earth metal, are: ErNi₂, 1167, NdNi₂, 1168, HoNi₂, 1169, DyNi₂, 1170, TbNi₂, 1171, PrNi₂, 1172, and GdNi₂, 1173.

From the magnetocaloric material curve charts, FIGS. 11A through 11H, the degree change in temperature for a material at a certain magnetic field strength is charted. This y-axis value can be plugged in as the x-axis value for the chart in FIG. 10 to find out the overall pressure change produced by each heat wheel, 420 & 955.

The actual temperature change of the internal atmosphere is not taken directly from the magnetocaloric material chart; instead, the temperature change is a function of two transient heat transfer analysis equations set equal to each other. This equation is commonly found in heat transfer texts. The following explains the way that from these two equations, the internal atmosphere temperature change, rpm speed, volume ratio of magnetocaloric material to internal atmosphere, power, and particle size of the nanopowder can be calculated. The specific equation involves the natural number e, with the Biot number and the Fourier number in the exponential. The equation is (T(t)−T(infinity)/(To−T(infinity))=ê(−h*A/p*Cp*V*t). The left hand side equals ½ if the change in temperature of the material being heated equals ½ of the temperature change of the material that is doing the heating after time t. The other variables are: h the heat transfer coefficient, A the surface area, p the density, Cp the heat capacity, and V the volume. The variables A and V can be roughly related to a sphere that is equivalent to the nanopowder particle size, with the actual ratio differing some due to the fact that a nanopowder particle will not be perfectly spherical. With all the variables except t and the A/V ratio held constant, the time taken for a particle to reduce to half of its starting temperature can be adjusted by adjusting the particle size. Since the time taken for a material to reach its final temperature takes an exponential amount of time, cutting down on this time increases the rpm speed possible and can be done by letting the material being heated attain only a fraction of its final temperature, in this model's case, ½. The material being heated is the internal atmosphere and the material doing the heating is the magnetocaloric material. Due to the heat wheel and the geometries of its passageways, the internal atmosphere only has 5/12ths of a revolution to reach ½ of the temperature change that the magnetocaloric material undergoes. Thus, the smaller the particle size, the larger the A/V ratio is, and the shorter the time period is to heat to half temperature; and, with a shorter time period to heat comes a faster rpm speed. A particle radius of 15 nanometers was found to be sufficient to produce high enough rpm speeds for the material Gd₅(Si_{X}Ge_{1-X})₄.

To calculate the max rpm speed, solve for t for the material Gd₅(Si_{X}Ge_{1-X})₄ at half of its final temperature. The variable t, differing slightly depending upon X, equals 91.88775*10̂−6 seconds to cool to half its temperature in ethane at a density of 485 kg/m³, with the answer differing for different inner atmospheres and densities. The engine completes a full rotation in 12/5*t=220.5306*10̂−6. This gives a max rpm speed of (60s/1 min)*(1/220.5306*10̂−6)=272,000 rpm.

The volume ratio for which the magnetocaloric material loses temperature at the same rate as the internal atmosphere gains temperature can be calculated by reducing the transient heat transfer equation to the form ê(−m₁*t)=ê(−m₂*t), and setting m₁=m₂, and solving for the unknown volume. Then, by putting _{Vethane}/V_{Gd5(SiXGel-X)4}, the ratio by volume of ethane to volume of Gd₅(Si_{X}Ge_{1-X})₄ is 66 to 1.

The turbine depicted only needs around 200 psi constantly to operate for a psi inside the turbine housing below 75 psi. Turbine operating parameters can be calculated from topics in aeronautical engineering, specifically in nozzle design. The heat wheel must be large enough so that density within a heat wheel chamber does not drop substantially to change the gas-liquid phase vapor point as the chamber crosses over a high velocity nozzle. The density drop can easily be held within 1-3 kg/m̂3 by changing nozzle parameters; and can be calculated for by first calculating the mass flow rate through the high velocity nozzle. The flow rate and the temperature that the fluid decreases by due to traversing the nozzle determines how much power the engine can output. If the power calculated is not adequate, the large heat wheel, 420, the nozzle velocity, and the turbine can easily be enlarged. Increasing the psi is another alternative. The magnetic field can be tweaked to get the operating psi in the correct range. Also, the operating temperature can be changed to to get the operating psi in the correct range. Moreover, the magnetocaloric material can be changed to get the operating psi in the correct range. Also, the turbine depicted will provide around 160 horsepower, at around 45,000 rpm. Since the bearings are of the magnetic levitation type and the gears are magnetic, the engine can operate at virtually any rpm speed without any problems. The turbine depicted

For supersonic nozzle velocities, the mass flow rate and the power can be calculated from the fluid density and the nozzle throat area.

The large heat wheel, 420, was calculated to produce 300 kilowatts at 45,000 rpm given the aforementioned data, and 300 kilowatts equals 400 horsepower available for the turbine to convert into mechanical power. Since the turbine depicted is 40% efficient, the turbine depicted will output 160 Horsepower. The heat wheels shown are not to scale for the first embodiment. The heat wheel depicted in the first embodiment is only large enough to operate below about 10,000 rpm. A larger heat wheel can operate at 45,000 rpm or higher with the limiting factor being the centripetal force of the fluid upon the nozzles. The centripetal force should add only a small fraction of force to the psi being exerted at any nozzle.

Fractions of final temperature other than ½ could be used, but ½ is an easy fraction to work with and simplifies the analysis. In this fashion, ½ of the temperature change, of a magnetocaloric material due to a magnetic field strength, is multiplied by a y-value of FIG. 10 at a certain temperature X, to obtain the actual pressure being applied to a high velocity nozzle of the turbine.

Some turbines may not use high velocity nozzles, 423; to the point of being supersonic and hence, lower velocity nozzles, may be used in this case. Also, the turbine housing, 533, will be different when using some turbines. The differences in turbine housing, 533, structure will depend upon the pressure flows that the turbine in question will need to optimally operate.

The coolant piping will now be described. The coolant piping is needed to cool the engine's superconductors when the engine is not running cold enough to self cool them. There are two coolant output pipes, 425, that pump coolant from the refrigeration device, 103, to the superconducting magnet assemblies, 419 & 537. The coolant then exits through the two superconducting magnet assemblies to superconductive & magnetic bearing housing coolant pipes, 430, and enters superconductive & magnetic bearing housings, 543, to cool housing superconductors. The coolant then exits the housings and enters the two coolant input pipes, 426, to return to the refrigeration device, 103.

The engine piping will now be described. The internal atmosphere and magnetocaloric material in nanopowder form flow as one throughout the engine piping; so, describing that one flows through the engine inherently means that the other also flows through the engine in the same proportions. The nanopowder starts out in the large heat wheel housing, 547, and flows into the turbine housing, 533. The nanopowder then exits the turbine housing, 533, and flows into the two turbine exhaust pipes, 432. The nanopowder next flows through the two turbine exhaust pipe reducers, 853, and into the two turbine exhaust to small heat wheel pipes, 429, and then through the two inlet heat wheel housing lofts, 535, and next into the two small heat wheel housings, 546. The nanopowder then flows out through the two small heat wheel housing to heat exchanger pipes, 427, and into the heat exchanger, 102. The nanopowder next flows through the two heat exchanger to large heat wheel housing pipes, 428, and then through the two inlet heat wheel housing lofts, 535, where the nanopowder completes the nanopowder's internal closed loop since both inlets enter into the large heat wheel housing, 547.

Some internal engine surfaces may need an erosion and abrasion resistant thin film coating in high velocity areas when the magnetocaloric nanopowder being used is notably hard. A nanopowder particle is of such low mass that its kinetic energy is not normally high enough to cause abrasion or erosion unless it is traveling at high speeds such as the supersonic speeds produced within the high velocity nozzle, 423. Also to produce erosion or abrasion along a surface, the nanopowder particle must be harder than the surface. Silicon dioxide is reasonably hard and can be grown upon the surfaces inside the engine by chemical vapor deposition in nanometer thicknesses to provide erosion and abrasion protection from magnetocaloric nanopowder in areas if needed. If higherMe abrasion and erosion resistance is needed, then a carbide based thin film can be used, or a suitable alternative film.

The heat wheel and turbine depicted are of welded construction, although they could be formed by other suitable metalworking processes. Within the turbine, 421, rods extend through the width of the turbine to hold the turbine end-plates together. The rods are welded at the ends to the end-plates so that tolerances of the turbine housing, 533, can be tighter than with bolts and nuts. Similarly within the heat wheels, 420 & 955, the walls which separate each heat wheel into 12 sections are welded at their ends so that the heat wheel housings can also have tighter tolerances than would be possible with bolts and nuts. The heat wheels, turbine, coupling disks, and bearing disks depicted are welded into place on their respective axles for simplicity. The axles depicted are at least 17 mm in diameter but need to be thicker for higher horsepower applications. The axles will also need to be thicker to prevent bowing of the axles when high turbine pressures are sought.

Many parts used herein are the same, and as such, can be repeatably used within the embodiment. However, when some parts are reused elsewhere they have holes in them that no longer have a use when placed in other locations. For this reason plugs are welded in so that parts may be easily reused elsewhere. There are three such plugs, all seen in FIG. 5B. Some plugs that are machine drilled may optionally be not drilled instead of plugged.

When filling the embodiment with an internal atmosphere and magnetocaloric nanopowder, the internal atmosphere should be evacuated and filled with the internal atmosphere enough times to purge the starting internal atmosphere A fill fitting can be welded to one of the pipes leading into the large heat wheel. This way if the correct amount of internal atmosphere and magnetocaloric nanopowder is pre-measured out, the embodiment can be filled by turning the large heat wheel by external coupling so that the nanopowder and internal atmosphere are dispersed throughout the embodiment, by the embodiment. This is assuming the superconductors and superconducting magnet assemblies are already in the proper operating state. Otherwise, most turbines can function as pumps to disperse the internal atmosphere and magnetocaloric nanopowder if a filling fitting is placed in the turbine exhaust pipe, 432. The filling fitting will pass the nanopowder easier if the nanopowder is per-dispersed by stirring before it passes through the fitting. Once filled, the fill fitting can be welded over for maximum internal atmosphere retention. A low melt alloy can be used for welding over the fitting so the fitting's seal with the pipe is not altered, and so the weld can be removed in case the embodiment ever needs to be evacuated.

The permeability of aluminum & titanium, near the permeability of free space, makes aluminum and titanium good materials to build the heat wheels, heat wheel housings, and outside structure of the superconducting magnet assemblies out of Since the permeability of aluminum and titanium is close to that of free space, the magnetic field within the heat wheels will be similar to the field at the same distance in free space. If steel were used instead, its higher permeability will shunt and attenuate the magnetic field.

There are three operating regimes. The first regime is when the thermal energy going into the first embodiment is less than what the embodiment is generating in energy. The embodiment will eventually slow to a stop unless its generating output is lowered to less than what thermal energy the embodiment is absorbing. Since this embodiment will come to a stop if not fed heat energy, this embodiment is not a perpetual motion machine. In the second regime, if the constraint that equal or more heat energy is coming into the embodiment than what the embodiment is generating in energy is always true, which can be the case for almost all refrigeration setups during their lifetimes, the embodiment will always refrigerate by absorbing heat energy and generating energy in another form. In the third regime, since heat transfer is higher when a higher temperature difference occurs, the embodiment will often start at the first regime in which the embodiment starts outputting more energy than the embodiment is receiving by lowering its internal heat energy. However, at some point the embodiment's temperature becomes so low that the second regime starts to happen and the embodiment starts to absorb as much or more heat energy than the energy the embodiment is generating and the embodiment enters into a homeostasis. This third regime, a combination of the first and second regime, is the usual operating regime. If the internal energy ever becomes too low, the valves can always be partially closed to lower the generating output power so that the internal atmosphere doesn't start to become a solid.

If the whole embodiment were to be miniaturized so that it operated at lower power and its external coupling components removed, along with the heat exchanger and its components, and represented by a box, the box would be a refrigeration device, 103, with two pipes with helium coolant exiting and two pipes with helium coolant entering. The exiting and entering pipes may be combined into one respectively if two pipes entering and exiting are not desired, since this will not affect operation of the refrigeration device, 103. This refrigeration device, 103, must transport the energy that was heat to somewhere else, since energy cannot be destroyed under energy conservation laws, and that transport can be done as said prior by transporting it electrically. If this electricity can no longer be stored or used, this electricity can be dissipated by Joule heating outside of the volume being refrigerated. Joule heating can also be accomplished by friction if the refrigeration device, 103, is externally coupled to a rotor and brake pad by applying friction upon the rotor. Helium is needed for type-1 superconductor cooling, but if the cooling requirements do not need to be cool enough for type-1 superconductor cooling, another internal atmosphere can be used. A helium atmosphere can cool to around 3.5 degrees kelvin. A nitrogen atmosphere can provide more cooling power to around 65 degrees kelvin, and a ethane atmosphere can provide even more cooling power to around 97 degrees kelvin.

Since the main engine can operate at temperatures below 100 Kelvin, the main engine can also be used to cool high temperature super-conductors below their critical temperature. This means that a refrigeration device, 103, would not necessarily be needed since the main engine is the same model scaled up and running at higher but still superconductive temperatures and can also be used to cool the superconductors used herein just as the refrigeration device does. However, if low temperature superconductors are used and an internal atmosphere other than helium is used, or if very high magnetic fields are wanted for a greater magnetocaloric effect, a refrigeration device, 103, will be needed. Also for the refrigeration device, 103, whatever the coolant is cooling functions the same as a heat exchanger, bringing heat energy into the device for external generation and for the continuance of operation of the refrigeration device, 103.

The heat exchanger design is important and varies depending upon the application sought. There are a few heat exchanger types used herein, all with their respective pros and cons. A central aspect of each type of heat exchanger is how each type of heat exchanger deals with the problem of water vapor from the air, or a pool of water, freezing inside the heat exchanger. Since these embodiments can extract so much heat, there are little scenarios where the heat exchanger does not have to be designed for the eradication of ice formation. Example scenarios are when the engine is operating as a refrigerator with the heat exchange indirectly taking place through the walls of the space being refrigerated, where the space is part of the internal closed loop, or where the space is connected through the heat exchanger but running on a separate closed loop, also not part of the external atmosphere.

All heat exchangers used herein should generally have a short distanced height. The reason for this is that the external atmosphere generally flows from bottom to top, through the height of the heat exchanger; and, this distance must be kept short, since the heat exchanger is extracting heat at such a great rate in this direction, so that maximum heat extraction occurs in ambient air. However, if a fuel is used to preheat the air, this distance can be longer to absorb the most heat from the fuel. A heat exchanger that can have relatively any height and that has great utility specifically in this embodiment is the basic spiral heat exchanger, 1278, that can be seen from the side in FIG. 12A and from the top in FIG. 12B. This specific heat exchanger is unique from previous art. The internal atmosphere entrance, 1274, loops around and returns at the internal atmosphere exit, 1275. The external atmosphere, 1277, is marked and flows either into or out of the drawing, or in other words perpendicular to the drawing. As the heat exchanger wraps itself around in more and more layers, the surface area increases exponentially with increasing radius and makes a fairly compact heat exchanger possible. In this fashion, the height can be decreased by wrapping more layers to keep the surface area equivalent to what the surface area was before the height decrease, which makes the height easy to change for this heat exchanger.

This basic spiral heat exchanger, 1278, is also optionally counter-current. As depicted, the divider walls, 1276, are pictured together; but, if the walls are spaced offset of each other the heat exchanger is no longer counter-current and the surface area doubles. When counter-current, the heat exchanger walls are more uniform in temperature; whereas when non-counter-current, the heat exchanger will absorb heat at a faster rate due to increased surface area. Generally at higher engine powers being supplemented by fuel the engine would benefit by being non-counter-current where the engine can absorb more heat; while generally when fuel-less the embodiment will benefit by a counter-current design where ice accumulation would otherwise be more of a problem by accumulating non-uniformly.

A heat exchanger assembly that shows great utility in this embodiment is depicted in FIGS. 13A, 13B. The heat exchanger assembly is of the anti-freeze type for roughly any engine size and roughly anywhere on earth. This assembly allows the engine to run off of only ambient air. The bottom half of this assembly in a section view is shown in FIG. 14B, with the blower, 1379, not sectioned. In FIG. 13A, there are two basic spiral heat exchangers, 1278, showing that any number of basic spiral heat exchangers, 1278, may be easily stacked upon one and another. Dividing a heat exchanger in half and stacking the resultant two is a good alternative to minimizing the height by increasing the radius. A combination of the two height adjustment methods make the sizing and fitting of a heat exchanger assembly much easier. A heat exchanger entrance, 1382, and heat exchanger exit, 1383, has been added in FIGS. 13A & 13B to the basic spiral heat exchangers, 1278, for the internal atmosphere to flow through, and to provide structural support to mount the basic spiral heat exchangers, 1278, by.

The basic spiral heat exchangers, 1278, and the hydraulic motor, 1385, are stationary with respect to the rest of the engine while the rest of the components making up the heat exchanger assembly are movable by method of the hydraulic motor, 1385, connected by way of the blower pipe, 1380. And, within the blower pipe is the center shaft, 1492, for structural support. This blower pipe, 1380, to hydraulic motor, 1385, connection can only be seen in FIG. 13B. The difference between FIG. 13A and FIG. 13B is that the hydraulic motor, 1385, has the blower pipe, 1380, raised in FIG. 13A, and lowered in FIG. 13B. In between the anti-freeze bath vats, 1381, the center shaft, 1492, is connected to the blower pipe, 1380, such that air is still allowed to flow through the blower pipe, although this connection is not depicted. As a result of the hydraulic motor, 1385, the insulated top plate, 1384, can be lowered onto the top of the top heat exchanger. Simultaneously, the top anti-freeze bath vat, 1381, lowers onto the top of the next lower heat exchanger, while all heat exchangers are lowered out of the anti-freeze within the anti-freeze bath vats, 1381. The purpose of raising the anti-freeze bath vats, 1381, is to supply heat by direct contact of the anti-freeze to the heat exchanger. The purpose of lowering the anti-freeze bath vats, 1381, is to thermally insulate the heat exchangers when raising the heat exchangers out of the anti-freeze. By insulating the heat exchangers, the engine will be able to sustain its operating temperature, and the operating temperature of the anti-freeze much easier when powered down.

The basic spiral heat exchangers, 1278, should be encased with a high grade insulator along their sides that is thick enough so that heat transfer along the heat exchanger sides is negligible. Furthermore, the insulated top plate, 1384, and the bottom of the anti-freeze bath vats, 1381, should likewise be insulated. With the insulation strategically in place, the basic spiral heat exchangers, 1278, will have negligible heat transfer through their top and sides when the anti-freeze bath vats, 1381, and the insulated top plate, 1384, are fully lowered. The remaining uninsulated bottom side of the basic spiral heat exchanger, 1278, will be partially insulated from large conductive and large convective heat transfer when the anti-freeze bath vats, 1381, are fully lowered since the basic spiral heat exchangers, 1278, will not contact anti-freeze in this position and will be shielded from external wind by the anti-freeze bath vats, 1381. The connection along the outside of the insulated basic spiral heat exchanger, 1278, with the inside of the anti-freeze bath vats, 1381, should be close enough or have a weather seal so that convective heat transfer is negligible.

FIG. 14B shows a section view of the bottom half of FIGS. 13A and 13B, without the blower, 1379, sectioned. FIG. 14B only includes up to the bottom anti-freeze vat bath, 1381, since that is all that is needed to understand the rest of the internals of the anti-freeze based heat exchanger assembly. The blower, 1379, forces air through the blower pipe, 1380. Other one-way air valves will work, but a generic valve, 1488, is depicted within the blower pipe, 1380, around the center shaft, 1492, that stops reflux back into the blower pipe, 1380, when the blower, 1379, is turned off. Reflux may also be stopped by having the blower above the liquid line. The valve, 1488, is allowed to move freely between the two valve stoppers, 1489. Air is allowed to pass around the valve, 1488, and on to the next anti-freeze bath vat through the next blower pipe, 1380. The center shaft, 1492, provides a strong structural connection between the hydraulicly moved parts. The external ambient air is passed through the blower pipe, 1380, into the accordion screen compartment, 1486. The accordion screen compartment, 1486, is separated from the rest of the anti-freeze bath vat, 1381, by the screen retention screen, 1487, a large mesh screen that provides negligible interference to the passage of air bubbles. The accordion screen compartment, 1486, is shown without the accordion screen. The accordion screen is similar to the filters used in car air filters but can also made of metal or made of a ceramic material, etcetera. If the accordion screen is zig-zaged in shape, like an accordion, more bubbles per unit volume will be made which is optimal. The mesh size of the accordion screen should be of the right size to produce bubbles roughly between 0.8 to 1.0 millimeters in radius. This radius range maximizes bubble rise velocity to roughly above 25 cm/s and produces larger heat transfer by using smaller bubbles. Larger bubbles can be used with a radius from 1 millimeter to 4.5 millimeters, and a little larger in radius, that result in rise velocities over 20 cm/s. This radius is for water, so the ideal mesh size will depend upon the type of anti-freeze, the amount of water mixed in the anti-freeze, the height of the heat exchanger, and the transient heat transfer of the size of the bubble to produce the most heat transfer through optimal bubble size. Any type of anti-freeze has great utility in this embodiment when the anti-freeze depresses water's freezing point very low, is very miscible with water, does not have too high of a viscosity at lower temperatures, and when the anti-freeze is able be separated from water by reverse osmosis. A choice of anti-freeze can be the solution of water and, 30% by mass, calcium chloride that will depress the freezing point of water to −46.1 degrees Celsius. The reverse osmosis system should increase or decrease its water output to keep the concentration close to to 30% for optimal freezing point depression, which can be measured by a conductivity sensor placed inside the solution and can be controlled by a water drainage valve, controlled by the electronic controls unit 309, based from the input of the conductivity sensor.

In any case on ground on earth, for an engine outputting 160 horsepower, the water should not build up within the heat exchanger at a rate greater than 1 gallon per minute. This is a worse case scenario at 100% dew point and 104 degrees Fahrenheit. Since a water vapor concentration versus temperature curve varies exponentially with temperature and the dew point is usually much less, the realistic rate of average water accumulation values will be on average much less for most parts of the world. Ten typical, under the kitchen sink, reverse osmosis water systems with high capacity membranes can extract, in unison, 1 gallon of water per minute, which meets the worst case scenario. For many parts of the world, ten typical reverse osmosis water systems will not be required.

In FIG. 14B anti-freeze flows in through the anti-freeze inlet, 1490, and out through the anti-freeze outlet, 1491; so that when the heat exchanger is within the anti-freeze, the anti-freeze makes a complete loop through the spiral heat exchanger. The top of the spiral heat exchanger should have a path impressed upon it for the drain pipe connected to the anti-freeze outlet, 1491, so that the heat exchanger maintains a good seal with the vat when the vat is lowered. The anti-freeze loop also goes through a reverse osmosis system to remove water from the anti-freeze. When anti-freeze flows inside an osmotic membrane, a water heater can be on the outside of the osmotic membrane so that the water traversing the membrane will not freeze upon being extracted since the water will be supercooled and will easily freeze in most scenarios.

The anti-freeze inlets and outlets should be relocated, in the case of an anti-freeze with different densities due to different concentrations of water at different places, especially if density is highly inconsistent, since different concentrations of the solution will be less dense and rise to the top of the vat; and hence filtering can be optimized by objectively filtering portions with higher water concentrations. Although, due to complex flows and heat exchanger types and sizes, this might not always be more optimal for water extraction, especially for smaller heat exchangers or when the anti-freeze is greatly perturbed.

If there is a powered down feature, the anti-freeze based system should have a separate heater within the anti-freeze bath vat to heat the anti-freeze. This heater counteracts cooling of the anti-freeze by the heat exchanger when the anti-freeze is separated the from the heat exchanger. When the anti-freeze is separated from the heat exchanger the engine is considered powered down. The anti-freeze could potentially freeze by loosing heat to the heat exchanger in powered down mode without a heater. However, a separate heater will not be needed in powered down mode if the reverse osmosis system's water heater transfers heat at rates, into the anti-freeze, that are equivalent or greater to the rates that the anti-freeze is loosing heat to the heat exchanger at. If heaters are used, they will be powered from the electronic controls unit, 309.

Electrolysis can be used to take water out of the anti-freeze, especially when the anti-freeze is an aqueous salt solution, and especially when the water does not build up at a great rate, which happens with smaller engines. Some energy will be needed to separate the water into hydrogen and oxygen. This energy can be mostly conserved though. If the hydrogen and oxygen being produced is combusted and ran back through the heat exchanger the energy used to separate the H₂O can be mostly conserved. The goal is to have the water pass as heated vapor through the heat exchanger and into the external atmosphere without much water vapor condensing back, inside the heat exchanger. In this way, water vapor that passes into the heat exchanger can be eliminated by passing the same water as water vapor at a higher temperature through the heat exchanger; or, the hydrogen and oxygen could not be ran back through the heat exchanger which would result in a high loss of energy with a higher water removal rate.

If the anti-freeze is not miscible with water, the anti-freeze can still be used but the water extraction process must be altered in a way that is mechanical. If the anti-freeze is not miscible, the freezing point of water will not be depressed and ice will directly form on top of the inside of the anti-freeze bath vat, 1381, if the anti-freeze is denser than water and ice, or ice will directly form on the bottom of the inside of the anti-freeze bath vat, 1381, if the anti-freeze is less dense than water and ice. Some ice will form inside the air bubbles, while the bubbles are in the middle of the heat exchanger; and, this ice will flow to its resting location along the top or bottom of the vat, depending upon the density of the anti-freeze. If ice collects along the top of the vat, ice can be mechanically scooped off the top of the vat for water extraction and put into a bin to catch the small amount of anti-freeze also removed so that it can be separated and put back into the vat. If ice collects along the bottom of the vat, mechanical methods could still be used, although not as easily, or a heated reverse osmosis membrane can be applied along the bottom of the vat so that ice can drain from the bottom of the vat and be drained out of the embodiment. Also, ice will form as the bubbles rise and the ice will then sink or float depending upon the density and must be removed by one of the above methods. Carbon disulfide can be used as an anti-freeze that is heavier than water and ice, and is non-miscible. Isohexane can be used as an anti-freeze that is lighter than water and ice, and is non-miscible.

The pros from using a non-miscible anti-freezes are that the anti-freezes are generally capable of being operated at much colder temperatures, and that separation is not much harder to achieve. Operation at colder temperatures means higher power input and smaller heat exchangers. Some ice will form along the heat exchanger walls from water vapor from adhering bubbles, but the amount will be small and the heat exchanger could be operated for long durations at high powers between being separated from the anti-freeze and heated with fuel briefly to remove ice. To allow ice to pass through the bubbler when using a low density anti-freeze like isohexane, the bubblers could be made out of ceramic rods, similar to those used in fish tanks, instead of an accordion screen.

In all anti-freeze type heat exchangers, the method of heat extraction from the air is the same. Air is forced through a media within the anti-freeze that creates small air bubbles within the anti-freeze. The increased pressure from the anti-freeze increases heat transfer from the air bubbles to the anti-freeze. The large surface area of the total amount of air bubbles within the anti-freeze also increases heat transfer. Heat is transferred from the air bubbles, which are at ambient temperatures, to the anti-freeze which is at very cold temperatures due to the anti-freeze being in contact with the heat exchanger walls. Heat is then transferred from the anti-freeze to the heat exchanger. The anti-freeze separates the air from the heat exchanger walls. This separation stops ice from forming along the heat exchanger walls. The air bubbles start at the bottom of the heat exchanger and rise to the top of the heat exchanger, along the heat exchanger's height, where the bubbles exit from the top of the heat exchanger. Removing of ice can also be done by cycling two heat exchangers so only one is active while the other is getting rid of ice. Having a useable, non-active, heat exchanger also helps to ensure that an active heat exchanger can be rapidly shut off and an inactive heat exchanger can be turned on when an active heat exchanger is in danger of building up too much ice.

Since the heat exchanger can have relatively thin metal walls, at incredibly cold internal temperatures, the heat transfer can be immense to the point that the anti-freeze is at a risk of freezing, especially when contact is first made between the anti-freeze and the heat exchanger. This can also be a problem for other heat exchanger types. To alleviate this problem, the heat transfer coefficient can be tweaked. The easiest way to tweak the static temperature difference between hot and cold sides is by adding a layer to the heat exchanger walls that has a fairly low heat transfer coefficient, that is also highly variable depending upon layer thickness. A plastic is a good example of such a layer. This layer can be applied to the heat exchanger walls internally, between the internal atmosphere and the heat exchanger walls so that freezing is more protected against. Also by applying the layer inside, the layer is protected from burning fuel, corrosive anti-freeze, the sun, radiation, the external environment, etcetera. If the layer will remain unreacted externally, applying it externally can be done and will yield the same effect as applying it internally. Scaling down the heat transfer coefficient will scale up the surface area required to maintain the same total heat transfer though requiring a larger heat exchanger. Requiring a larger heat exchanger can be alleviated by making the heat exchanger more compact by increasing the surface area per volume of the heat exchanger.

For engines outputting at a high power density and hence requiring a high power density input, a fueled heat exchanger has great utility It is possible that this embodiment could operate at 100% fuel efficiency or greater by cooling the air-fuel mixture beyond its starting temperature. This would allow greater operating times between refueling and lower operating costs than normal engines being used that are not of this type. Many aviation engines would benefit by a higher power density model of this embodiment. Other powerful engines would benefit as well like exotic sports cars or military tank engines. These powerful engines can be operated by turbines powered by thousands of pounds of force per square inch through my embodiment. Furthermore, turbine operating speed could be hundreds of thousands of revolutions per minute since the embodiment has no upper limit placed upon revolutions per minute. To meet the resultant huge power requirements that will be required, a heat exchanger can be powered by almost any type of fuel. Most fuels burn around 2000 degrees Celsius in air. If the heat exchanger volume is 1 m³, the heat transfer coefficient of the heat exchanger is 35, the surface area density of the heat exchanger is 100 m²/m³, and the burn temperature of the fuel in air is 2000 degrees Celsius, all parameters constant, the heat transfer is 1*35*100*2000=7 megawatts, equal to 9,387 horsepower, available for the engine to convert. Horsepower rapidly increases with increasing turbine size, so scaling up the rest of the engine to make use of incredibly high horsepower input is easy.

Another operating regime is if this embodiment is operated at typical outdoor temperatures. A fueled heat exchanger can be used whenever power is needed. The pro of this design is that the operating temperature of the engine does not need to be maintained as closely when the embodiment is not running, just the operating temperature of the superconductors needs to be maintained unless permanent magnets are used in their place. This simplifies the complexity, but efficiency is not as high and more fuel has to be used.

For high power density and very low fuel consumption, the engine can use fuel intermittently as needed to stop ice formation. Using fuel intermittently makes increasing fuel efficiency over 100% much easier to achieve For aviation engines cruising at 35,000 feet altitude there is very little water vapor in the air due to the roughly constant −50 degree Celsius temperature. Hence, for high cruising airplanes, fuel consumption drops to relatively nothing once cruising altitude is reached since there is relatively little deicing required. Hence, this embodiment will allow airplanes with even small fuel tanks to travel much greater distances.

For small engines, like motorcycle engines around 13.4 horsepower equivalent to 10 kilowatts, a fueled engine has great utility. This engine can also power around 5-8 homes. This engine can use fuel for deicing like above, but due to the engines very low thermal power input requirements, fuel is not usually needed to run the engine. Fuel is only needed for deicing. Since this engine can easily be operated by only dropping the air in the heat exchanger by 3 degrees Celsius, or by design even less of a temperature change, ice buildup almost never occurs except when the ambient air temperature is colder than 3 degrees Celsius In some places, like Miami Florida, this heat exchanger will never need fuel for deicing since the temperature is never colder than 3 degrees Celsius In other colder places, this heat exchanger will only need fuel during some parts of the year. Hence, a small engine of the heat exchanger fueled type has great utility by being somewhat, depending upon location, fuel-less.

Another type of heat exchanger is the small engine power input to large heat exchanger power output ratio type. This type is for heat exchangers filled only with air. The requirements for this type are met when the engine power input requirement is small enough or when the heat exchanger power output, largely a factor of heat exchanger size, is large enough that ice build up, in thickness, along the walls within the heat exchanger takes place at a small rate. Although fuel can easily device the walls, the object is to have zero running costs, and hence zero dependability upon fuel. This type of heat exchanger will typically only cool the air inside it by 5 to 10 degrees Celsius or less, depending upon engine power and heat exchanger dimensions. Thus, solar energy, especially if concentrated by a Fresnel lens or mirror array can easily offset this temperature difference so that ice build up does not occur. Also when ambient air temperatures are over the temperature change that the heat exchanger will create, which happens during most warmer months in most places, no deicing is needed at all. Fuel might be used in cases of shady days. However, to completely be fuel-less and not rely on sunshine for this heat exchanger type, microwave radiation is preferred. Microwave radiation can easily be used to deice a heat exchangers walls, especially a heat exchanger similar to a shell and tube type. The amount of microwave radiation needed will vary depending upon the power being drawn from the heat exchanger, but if based around typical microwave ovens, the wattage will most likely be over 1000 watts. This wattage restricts the power of the engine from being too small since the engine will need to supply the power needed for the process is it powering, plus extra to supply power for microwave radiation deicing. Nevertheless, microwave deicing has great utility since the air within the heat exchanger will negligibly be heated and hence energy can be extracted from the air as normal, but water and ice will be heated very much by the microwave radiation and hence will be deiced. Since the water as liquid in the heat exchanger was previously vapor, even heating the water to near boiling will still result in energy gain.

The shell and tube heat exchanger can be turned into a microwave oven. In a microwave oven, a standing pattern is formed for very high energy transfer into water. The inside of the oven acts as a wave guide to bounce microwaves around. In the shell and tube heat exchanger, the shell will act as the wave guide. The external atmosphere openings of the heat exchanger can be covered with the same type of mesh screen on microwave doors to keep microwaves within, while allowing air to pass through for heat exchange. Air flow can be increased by increasing the surface area of the mesh screen. If microwave radiation passing outside of the heat exchanger is still too high to be considered safe, which is unlikely for smaller microwave radiation powers, a susceptor can be placed outside the external atmosphere openings to catch escaped microwaves. The tubes inside the heat exchanger will also bounce the microwaves off their walls; and, since the tubes are very convex, radiation will be greatly spread around the inside of the heat exchanger. A coat of PTFE, the same as Teflon, will help water to bead up and hence will increase the surface area of the heat exchanger contact with air, and decrease the heat exchanger contact with water, which is optimal for heat transfer. The forced convection fans can also be positioned to help keep water from heat exchanger surfaces. High pressure air nozzles can also be added and turned on intermittently to aide in water removal from heat exchanger surfaces.

Another variation is a heat exchanger combined with a heat reservoir. A heat reservoir acts as an extra heat source that can be charged when the engine is not being used much. The pro about this design is very large power generation for long durations, beyond what a fuel-less heat exchanger for mobile applications might be able to input, is possible. With this setup, the heat exchanger heats the heat reservoir while the engine is not outputting more power than the heat exchanger is capable of inputting This is the case when the engine is outputting a smaller percentage of its total output, like during idling or when the engine is not being used at all. An optimal choice of material to fill the heat reservoir with is FLiBe, a material also proposed to be used in nuclear reactors. FLiBe is a mixture of lithium fluoride and beryllium fluoride that has a melting point of 459 degrees Celsius, a boiling point of 1430 degrees Celsius, a heat capacity of 4540 kJ/m3, and a density of 1940 kg/m3, all of which makes it a superb material to draw many joules of heat from for long durations. A 2:1 mixture with proportions Li₂BeF₄ of FLiBe can provide 160 horsepower, equivalent to 120 KW, at a volume of 1.5 m3, for ((1.5*(1430−459)*4540*1940)/(120,000*3600))=29.7 hours. This duration can be even longer if energy is also drawn from FLiBe after it has solidified. In this design, the closed internal atmospheric loop must be allowed to go through the heat exchanger and heat reservoir in parallel, with the actual proportion of the total amount of flow rate going into the heat exchanger and heat reservoir being controlled by valve by the electronic controls unit, 309, dependent upon engine output power. The high price of the constituents of FLiBe dictate that cheaper materials will be used in FLiBe's place, except possibly where small heat reservoirs are used for high power and short durations like during acceleration, or where price is not a large factor, like in exotic sports cars.

When using a heat reservoir, if the power during operation is solely dependent upon a heat reservoir, the actual heat exchanger can be smaller since the heat exchanger would then only need to provide power to reheat the heat reservoir like recharging a battery. Since less power is required, lower power fuel-less heat exchanger types can be used. For larger power applications that can be fuel-less but need larger, short duration, power at times, a fuel-less based heat exchanger with a heat reservoir can be used as an alternative to a fueled design.

Also, a heat exchanger is not needed if the heat reservoir acts as the heat exchanger and a separate process heats the heat reservoir, like electricity from home power heating a car's heat reservoir while the car is not being used; or, colder heat reservoir fluids could be exchanged for hot fluids at a fuel station. Although, a heat exchanger would still be a good feature to have installed to maintain fluid temperatures when the car is not in use.

Nuclear power can be a heat source for the heat exchanger as well. Nuclear power can be handled very safely by this engine since the heat exchange from the nuclear fuel can be done in a separate loop which does not contaminate the engine by turning the engine radioactive. This engine also creates a safer environment for nuclear fuel by cooling the fuel more than would otherwise normally happen in typical environments. This engine can also make great use of lower quality nuclear fuel like spent nuclear fuel rods which are accumulating in great quantities. This engine is also more efficient at transforming heat energy into usable power than current nuclear reactor systems. Although this engine will likely replace nuclear power, the engine can ensure safer storage of spent fuel for the future, and continued energy extraction from spent fuel.

A body of water can also be used as a heat source for the heat exchanger, especially warmer bodies of water. As the body of water being drawn from nears freezing, the heat exchanger risks the build up of ice. This can be combated by switching the heat exchanger from being heated by a body of water to being heated by an air and fuel design or other aforementioned type. This setup can often be optimal for boats or power plant electricity generation, especially by coastal areas, where the body of water likely stays unfrozen year-round. Similarly, geothermal power may also be used as a heat exchanger heat source by drawing water from an aquifer. Also, submarines will now be able to be powered continuously by ambient water heat instead of the only other feasible method, by nuclear reactors.

For a small engine running near absolute zero that is used to power a single home, a flat heat exchanger can be used with no ice removal needs. This flat heat exchanger can easily fit upon the roof of the house. At a percentage of the total surface area of a roof, this engine can run a heat exchanger so cold that enough power is inputted from the heat exchanger to the engine for power, even with ice upon the heat exchanger 1 meter thick. At some point the ice upon the roof will reach a maximum thickness, depending upon ambient conditions and the amount of power being used, and will cease to grow.

From the previous example, a heat exchanger can also be built in the soil underground that has a heat transfer coefficient only 25% less than that of ice. In this example, ice formation will not occur since the heat exchanger is shielded from air. If the engine is also built underground in a bunker, people can avoid catastrophic events underground with no fear of being left without a never-ending supply of energy to do such things as boiling water. In this example, graphene or heat pipes can be added in the soil to increase the soil's heat transfer coefficient, making the size of the heat exchanger smaller.

Given that fueled heat exchangers can be much smaller, engines can be more powerful with fueled heat exchangers, that fuel is cheap and plentiful, that the price of the magnetocaloric material will be the largest cost factor, and that as a heat exchanger's size increases so does the amount of magnetocaloric material running through the engine, engines with fueled heat exchangers can be significantly cheaper upfront and can be more appealing in terms of power than other types. However, engines with fuel-less heat exchangers can be powerful enough for almost all applications. Furthermore, over the lifetime of the engine, a fuel-less heat exchanger will often pay for itself and be convenient by not needing fuel. This makes fueled and fuel-less types competitive and leaves the option of having cheaper, fueled, heat exchangers should magnetocaloric material prices rise significantly.

Heat exchangers with mechanical scrapers can also be used in this embodiment. Mechanical scrapers have been used in prior patents to remove ice crystals. However, there use makes the heat exchanger very non-compact which is not optimal in most situations.

Also, superconductive power lines can easily be a reality by using this embodiment to cool them, and using the energy absorbed while cooling the power lines to power the superconductive power lines. If these superconductive power lines are provided by the government, energy could be a free resource in the near future.

Some of the uses for specific magnetocaloric materials will be specified. The rare earths materials of the series RNi₂ in FIG. 11A are good for low temperature superconductor cooling and low temperature power production. The material GdNi₂, 1173, is more suited for high temperature superconductor cooling and power generation. Although GdNi₂, 1173, is much less powerful, it is much cheaper than Gd₅(Si_{X}Ge_{1-X})₄, FIG. 11C, and powerful enough to be used, which warrants its use as an optional replacement for Gd₅(Si_{X}Ge_{1-X})₄, FIG. 11C.

The material Gd₂In in FIG. 11B would be good for a powerful refrigerator with an ethane atmosphere due to the material's temperature range. From the curves in FIG. 11B, this material becomes hard to get power from at temperatures lower than about 100 kelvin unless a high magnetic field is used. Also, low magnetic fields should not be used since, as seen from the lowest curve, this material actually has a negative temperature change at temperatures lower than 100 kelvin. The curves in FIG. 11B are at 2 Tesla, 5 Tesla, 7.5 Tesla, and 10 Tesla for the curves from lowest to highest magnetic flux density respectively.

The material Gd₅(Si_{X}Ge_{1-X})₄ in FIG. 11C is great for operating when only a narrow temperature range is needed which applies to most engines. This material is also one of the most powerful magnetocaloric materials due to its giant magnetocaloric effect which can be seen from how all the curves reach very high temperature changes for a magnetic field change of 5 Tesla. This material tends to be more expensive though mainly due to the amount of Germanium used and, to a lesser extent, the amount of Gadolinium used. If Gd₅(Si_{X}Ge_{1-X})₄ were used in a typical car engine design, the engine and heat exchanger would cost around $6,000 to produce based on current prices; whereas if GdNi₂ were used in a typical car engine design, the engine and heat exchanger would cost around $2,000 to produce based on current prices. The difference in price would mean that GdNi₂ would be more optimal in a car engine. However if Gd₅(Si_{X}Ge_{1-X})₄ were used with a fueled heat exchanger, an engine and heat exchanger could be produced for around $6,000 that could power a fighter jet needing thousands of horsepower in thrust. Hence, both GdNi₂ and Gd₅(Si_{X}Ge_{1-X})₄ have great utility, albeit in different uses, as do the rest of the magnetocaloric materials specified. There are many other magnetocaloric materials to choose from too, and more being found. The materials specified here are some of the more notable ones.

The material Gd₅(Si_{X}Ge_{1-X})₄ in FIG. 11C varies in the domain of its curves along the temperature axis depending upon the constant substituted for X. The curve at the far left is for X=0.5 while the curve at the far right is for X=0. By varying the composition of the material by varying X, the material can be made optimal for an atmosphere of helium, nitrogen, or ethane, etcetera. Varying curves by varying composition is also done for (Gd_{1-X}Er_{X})NiAl in FIG. 11D, Er(CO_{1-X}Ni_{X})₂ in FIG. 11E, and (Dy_{1-X}Er_{X})Al₂ in FIG. 11G.

The material (Gd_{1-X}Er_{X})NiAl in FIG. 11D is good for superconductive cooling and power generation in atmospheres of helium and nitrogen. The material Er(Co_{1-X}Ni_{X})₂ in FIG. 11E is good for superconductive cooling and power generation in a helium atmosphere The material Gd₃Al₂ in FIG. 11F is good for wide temperature range refrigeration, superconductive cooling, power generation, and higher temperature engine operation with many possible internal atmospheres The temperature range of engines can also be widened by using two or more magnetocaloric materials in the same engine. The material (Dy_{1-X}Er_{X})Al₂ in FIG. 11G is good for superconductive cooling and power generation in all atmospheres. The material GdAl₂ in FIG. 11H is very cheap and good for superconductive cooling and power generation in many possible atmospheres.

### Operation

### First Embodiment

As the superconductors cool to their superconducting operating temperature, the bearing disks, 544, begin to float by magnetic levitation. Very large magnetic forces constrain the bearing disks, 544, to the center of their housings. Since the axles, 539 & 541, turbine, 421, heat wheels, 420 & 955, and coupling disks, 545, are connected to the bearing disks, 544, they are also centered and floating within their respective housings. Hence, no mechanical contact of moving parts is currently present in the engine.

The superconducting magnet assemblies, 537 & 419, are now charged so that the magnetic field within both superconducting magnet assemblies points in the same direction and is of the magnitude of roughly between 2 Tesla and 10 Tesla. The magnetic field cuts the internal atmosphere inside each heat wheel, 420 & 955, in half. In between each superconducting magnet assembly, 537 & 419, almost all of the magnetic field flows from one superconducting magnet assembly to the other superconducting magnet assembly do to their close proximity. The magnetic field than flows out the other side of both superconducting magnet assemblies, 537 & 419, where it is shunted within the steel end-plates, 205. The magnetic field is then shunted from the steel end-plates, 205, to within the steel frame, 101, where the magnetic field completes a full loop. Hence, almost all the magnetic field is made to flow through half of each heat wheel, and then made to be shunted back in a full loop so that the strong magnetic field does not effect anything, other than half of each heat wheel, externally or internally. The very small amount of magnetic field that does not do this will be negligible by method of the embodiment's design.

Next, one forward & reverse valve, 424, is opened while the other valve is closed. Choosing the one that is opened and the one that is closed depends upon the direction that one wants the turbine to spin. The valves are turned electrically by the electronic controls unit, 309, through the geared stepper motors inside the housings with geared stepper motor with positional encoder, 548. The exact positions of the valves are known to the electronic controls unit through the positional encoders.

To start the engine, the external coupling drive-shaft, 207, is turned to turn the axle connected to the turbine. If the external coupling drive-shaft is not present because the engine outputs electrical power, instead of mechanical power, by way of an internal generator connected to the turbine axle, electricity can be used to turn the generator by using the generator as a motor, thereby turning the turbine's axle As the turbine's axle turns, the axle connected to the heat wheels turns at the same rate due to internal coupling. The internal coupling works by using permanent magnets to make the coupling disks, 545, spin in unison. The axles always spin such that one axle spins clockwise while the other axle spins counter-clockwise, and vice versa, due to the internal coupling disks, 545.

As the axles spin, so do the heat wheels. The spinning of the heat wheels is what directly causes the embodiment's engine to start and carry on under its own power. The portion of the heat wheel that at any time is within the magnetic field of the superconducting magnet assemblies, 419 & 537, is referred to as the hot side of the heat wheel, while the portion of the heat wheel that at any time is not within the magnetic field of the superconducting magnet assemblies, 419 & 537, is referred to as the cold side of the heat wheel. The internal atmosphere and the magnetocaloric nanopowder within the heat wheel on the cold side is spun, by the spinning heat wheel, to the hot side where the magnetocaloric nanopowder heats up due to entering the magnetic field on the hot side of the heat wheel. The magnetocaloric nanopowder, now hotter than when it was in the internal atmosphere on the cold side of the heat wheel, transfers its heat into the internal atmosphere surrounding it.

This heat transfer takes place around the order of microseconds by using a nanopowder to transfer generally at least half of its new heat energy to the internal atmosphere A magnetocaloric nanopowder embedded in a medium is the enabling technology for this embodiment since it allows fast revolutions per minute due to its fast transient heat transfer. The fast transient heat transfer is due to the dispersion of the nanopowder in the medium allowing heat transfer instantly throughout the medium and due to the high surface area to volume ratio of the nanopowder being able to transfer heat rapidly.

Due to matching the transient heat transfer equations by volume, the magnetocaloric material loses degrees in temperature at the same time rate as the internal atmosphere gains degrees in temperature. The volumetric matching just so happens to work out such that the internal atmosphere is mostly gas with a small amount, by volume, of nanopowder; in a previous calculated example, only 1.5% was nanopowder by volume. By only having to use a small percentage of nanopowder, clogging from the nanopowder is not a concern. The resultant change in pressure of an internal atmosphere for a degree of heat energy an internal atmosphere absorbs is charted in FIG. 10 for starting degrees from 0 to 350 Kelvin.

Now that the internal atmosphere on the hot side of the heat wheel has been heated up by the nanopowder, the internal atmosphere is at a pressure a little above the operating pressure of the turbine. For the example of the 160 horsepower engine, the psi is above 200 psi. As seen in FIG. 4B, if the heated internal atmosphere continues to rotate with the heat wheel, it will cross a closed valve first, and then an open valve. The pressure will decrease a little in the section of the heat wheel that the heated internal atmosphere is in as the heated internal atmosphere expands to fill the volume surrounding the opened valve.

The internal atmosphere with nanopowder will flow through the passageways in front of the opened valves from the pressure created within each chambered section of heat wheel as that section passes the opening. In this way, near constant pressure will always be applied to the passageways on the hot side of the heat wheel. The turbine housing, 533, accepts this pressure from the large heat wheel, 420, to turn the turbine, 421. Since the magnetic field is not within the turbine, the internal atmosphere's pressure energy must be converted into kinetic energy that the turbine can use before that internal atmosphere enters into the turbine. This is what happens for any generic turbine. Turbines that need the internal atmosphere to not decrease in pressure once inside the turbine can use an open core superconducting magnet wrapped around the turbine housing, 533, to stabilize the pressure. The turbine, 421, depicted does not need a superconducting magnet wrapped around the turbine housing, 533.

For the turbine depicted, the operating pressure is applied to the high velocity nozzle, 423. The magnetic field within the high velocity nozzle is constant within the nozzle and as strong as the magnetic field within the heat wheels, so whatever happens within the nozzle is not effected by a changing magnetic field within the nozzle. The high velocity nozzle converts the potential energy bound within the pressure created by the heat wheel into kinetic energy by accelerating the internal atmosphere and nanopowder to supersonic speeds through the high velocity nozzle, although speeds can be subsonic for particular designs. The high velocity nozzle, 423, does this energy conversion with an operating pressure above 200 psi applied for the turbine, 421, depicted.

The turbine depicted, 421, captures the kinetic energy from the high velocity flow of the internal atmosphere coming from the high velocity passageway, 431, through adhesion. The turbine blades, now rotating at thousands of revolutions per minute from the power absorbed by adhesion, turn the axle on the turbine side, 541. This axle spins either the external coupling disk, 545, or an internal electrical generator to generate power. If the external coupling disk is used to generate power, the external coupling disk is magnetically coupled to the external coupling drive-shaft to generate power outside mechanically.

The large heat wheel, 420, does more work than just increase the pressure on the hot side of the heat wheel. The internal atmosphere and nanopowder fluid remaining in sections of the large heat wheel that was not outputted while the fluid was on the hot side crosses over to the cold side as the heat wheel spins. Upon crossing out of the magnetic field and entering the cold side, the nanopowder instantly cools to a temperature less than when it entered the hot side since the nanopowder gave off thermal energy while on the hot side of the heat wheel. The nanopowder now absorbs heat energy while on the cold side of the heat wheel and thereby reduces the pressure of the internal atmosphere within the cold side of the heat wheel. This reduction in pressure, along with less internal atmosphere being within the heat wheel sections after coming from the hot side, causes the sections of the heat wheel on the cold side to fill with more internal atmosphere and nanopowder from the inlet heat wheel housing lofts, 535. Now the heat wheel cycle is complete and continuously repeats from here.

The internal atmosphere is never separated from the nanopowder by any internal mechanism within the embodiment. The nanopowder is constantly being mixed with the internal atmosphere by the internal atmosphere's movement throughout the engine internals.

There is more to the cycle than just what surrounds the large heat wheel, 420. In the turbine depicted, the internal atmosphere, when injected into the turbine, leaves the turbine through the middle of the turbine housing. The internal atmosphere at the middle of the turbine housing is under vacuum pressure from the two small heat wheels downstream of the turbine housing by connection through the piping of the turbine exhaust pipes, 423. Hence, the internal atmosphere will eventually be pumped by the two small heat wheels into the heat exchanger.

Besides pumping the internal atmosphere, the two small heat wheels apply a pressure to the internal atmosphere while it enters and exits the heat exchanger to account and make up for pressure drops the internal atmosphere incurs while inside the heat exchanger. As the internal atmosphere goes through the heat exchanger, the internal atmosphere gains in thermal energy equal to what the fluid lost when the internal atmosphere yielded power externally by going through the high velocity nozzle and turning the turbine.

The internal atmosphere within the heat exchanger is also under vacuum by the cold side of the large heat wheel downstream of it. Hence, the internal atmosphere flows from the heat exchanger to the large heat wheel where the complete internal cycle repeats by the engines internal energy. As the engine internal energy lowers, the temperature lowers, causing more heat energy to flow into the engine through the engine's heat exchanger.

Roughly any engine can be converted into one that operates under this invention's principles. Therefore, any engine that is converted to work under this invention's principles is considered to be of an embodiment herein. For instance, a piston type engine can be made to work under this embodiment's principles. The following is how converting the engine would be done, which is generalized for converting any engine conceived.

First, the piston type engine's exhaust would go through a heat exchanger in a closed loop connected from the engine's exhaust to the engine's intake. Second, the internal atmosphere within the closed loop would be filled with one of the aforementioned atmospheres and filled with a magnetocaloric nanopowder. Third, a superconducting magnet, or a pair of superconducting magnets, field would be made to move over the parts of the engine's internal atmosphere that is supposed to be expanded during the engines expansion cycle. Similarly during the end of the engine's compression cycle, the magnetic field would be removed from those parts. For example, within a piston type engine the field would be within the piston's cylinder when the cylinder is expanding, and not there when the piston's cylinder is compressing. The moving of the field would be accomplished by moving the superconducting magnet or magnets. The field may also be moved withing the cylinder by moving the cylinder instead of moving the magnets. This process can be extrapolated to make virtually any engine into an engine of this embodiment. Although, the performance for many engine conversions will not be as great as the performance of an engine engineered and depicted in this invention.

In short, the magneto-caloric powder is used like a combustible fuel. The magneto-caloric powder is put under a magnetic field when an expansion cycle would occur if combustible fuel was being used; or, the magneto-caloric powder is taken out from under a magnetic field when a compression cycle would normally occur. Of course, both cycles are normally used, but an either-or Boolean relationship is also possible.

The internal atmosphere can also be a liquid or solid that produces work from volumetric expansion from magneto-caloric heat of a magneto-caloric powder dispersed within. Of course the engine would still be of this embodiment if a liquid or solid internal atmosphere is used, but the optimal design would be different.

As the density of a working gas is lowered, its liquid phase temperature span increases by raising the temperature that the liquid becomes a gas at. This allows more work to be taken from the fluid, from a single loop through the engine. Also as the density lowers, the base pressure of the fluid as the fluid goes from a liquid to a gas increases which limits supersonic fluid flow through a nozzle. A working knowledge of the fluid span and the fluid span's importance in achieving high power while keeping in mind the fluid span's possibility of limiting supersonic fluid flow is important.

The desired temperature in a large heat wheel chamber is the temperature at which the fluid is balanced between its liquid and vapor phase. This lessens the limiting of supersonic fluid flow by keeping the base pressure low and ensures a large change in pressure for a small change in temperature. A magnetic field will heat the fluid into the gas region; and energy can then be extracted from the gas phase up until the melting point of the fluid. Next energy can be returned to the fluid until the fluid is back at its starting temperature, the temperature between the liquid and gas phase.

### Second Embodiment

In FIGS. 15A & 15 B, there is a means for change, 1593, that changes the magnetic field, perceived by the magnetocaloric powder, 1596. This means for change, 1593, can also be mechanical, and can also result of movement of the powder instead of or in addition to movement of the magnetic field. An example of the movement of powder would be the movement of powder through the expansion chamber of a jet engine where the field can be static and stationary within the expansion chamber but the movement of the powder can still produce work upon the turbine blades in the expansion chamber. There is at least one magnet, 1594, and at least one expansion/compression chamber, 1595. The, expansion/compression chamber, 1595, expands or contracts to do work, or something within the chamber can do work as a result of the expanding and contracting gas within the chamber; which is another way of saying that work is done from the pressure changes within the expansion/compression chamber, 1595.

### Operation—Second Embodiment

The magnetocaloric powder, 1596, within the expansion/compression chamber, 1595, changes the temperature within the chamber, which in turn changes the temperature of the atmosphere within the chamber, which in turn changes the pressure within the chamber, which in turn allows work to be done from the pressure change. The abrupt changes in temperature causing the pressure change are caused by the powder being within a high magnetic field. As work is extracted from the inside of the chamber, the chamber looses energy which appears as a loss of thermal energy inside the chamber. When the chamber has reached its cold operating point, heat passes into the chamber to make up for the heat being lost by work being done. Some optimal atmospheres are helium, nitrogen, and especially ethane.

### Third Embodiment

This embodiment is the same as the first with the exception being the turbine and the turbine's components are set up for axial flow of the magnetocaloric powder. In other words, the magnetocaloric powder flows parallel to the axis of the turbine.

Due to the position of the turbine with the rest of the engine, the axial turbine right angle coupling wheel, 1603, meets with the axial turbine coupling wheel, 1604, at a right angle. This right angle meeting and the coupling magnets inside the wheels can be seen in FIG. 18. The axial turbine right angle coupling wheel, 1603, and the axial turbine levitation bearing, 1602, have open midsections to allow for the passage of magnetocaloric powder.

The axial turbine coupling wheel, 1604, is connected to the axle on the turbine side, 541. The turbine, not shown, goes around the turbine spindle, 1601. Also around the turbine spindle, 1601, is the axial turbine levitation bearing, 1602, and the axial turbine right angle coupling wheel, 1603. The previous parts of this embodiment are located within the axial turbine housing, 1705. Since the turbine only spins one way, the parts for reverse operation are not needed. As a result, the large heat wheel housing of the first embodiment has been changed to accommodate the axial flow turbine by being changed into the axial large heat wheel housing, 1706. One side of the axial large heat wheel housing, 1706, is plugged since reverse operation is not needed and the fluid flow is changed from going through the side to going through the middle through a chamber to accommodate a central axial turbine flow.

### Operation—Third Embodiment

The operation of the third embodiment is the same as the first embodiment with the exception being that the magnetocaloric powder flows through an axial flow turbine instead of a tangential flow turbine, and that there is no reverse operation because the axial flow turbine only spins one way.

### Fourth Embodiment

This embodiment is much like the first in that most of the parts are the same or function in a similar way, but this embodiment has been modified to accommodate more than one turbine. This embodiment accommodates six turbines, but could be made physically larger to accommodate more turbines. This embodiment models an industrial power plant engine.

All drawings, but the very last of the drawings, have been simplified by only showing one of the six turbines to ease finding and viewing parts. The part naming scheme is not the same for the series 33XX since there is no drawing page 33.

The magnetic shunt, 1901, routes the magnetic field from superconducting magnets, 2215. Passing through magnetic shunt, 1901, is the axle on the turbine side, 3300, in FIG. 23A. Strung upon the middle of the axle on the turbine side, 3300, is the turbine, 2421. Around the turbine, 2421, is the turbine housing, 2934. Near each end of the axle on the turbine side, 3300, is a magnetic bearing housing C, 3303, in FIG. 22 wherein a magnetic bearing wheel, 2523, is located strung upon the axle on the turbine side, 3300. At each end of the axle on the turbine side, 3300, is a small coupling wheel housing, 2219, wherein a small coupling wheel, 2522, is located strung upon the axle on the turbine side, 3300. The coupling wheels have permanent magnets, 2526. The bearing wheels have permanent magnets, 2526, and ring permanent magnets, 2527.

The central axle on the heat wheel side, 3301, in FIG. 23A has a large heat wheel, 2730, strung upon its middle. The large heat wheel, 2730, has a large heat wheel bearing, 2729, welded on each side of the large heat wheel, 2730. A large heat wheel bearing, 2729, has permanent magnets, 2526, around the circumference and along a ring of holes on the outer top face. Around the large heat wheel, 2730, is the heat wheel housing, 2003. The halves of the heat wheel housing, 2003, are mirrored along the XY plane that the large heat wheel, 2730, lies parallel to. The whole embodiment is also mirrored along this XY plane. Each side of the heat wheel housing, 2003, is part of a pedestal, 3304, in FIG. 19, that supports a large coupling wheel housing, 2004. Within a large coupling wheel housing, 2004, is a large coupling wheel, 2525. The large coupling wheels, 2525, are strung on the central axle on the heat wheel side, 3301. On each side of a large coupling wheel housing, 2004, is a small pump magnetic gear box housing, 1900. Within a small pump magnetic gear box housing, 1900, are staggered medium coupling wheels, 2524.

Near each end of the central axle on the heat wheel side, 3301, are two medium coupling wheels, 2524, strung on the axle. These central medium coupling wheels, 2524, are connected by magnetic coupling to other peripheral medium coupling wheels, 2524, in a staggered orientation so as to allow more closely spaced coupled wheels. Each peripheral spaced medium coupling wheel has its own axle, magnetic bearing wheel, 2523, magnetic bearing housing B, 3302, centrifugal pump, 2320, small pump housing, 2005, exhaust loft, 2217, and intake loft, 2218.

At each end of the central axle on the heat wheel side, 3301, is a magnetic bearing housing A, 2114, wherein a magnetic bearing wheel, 2523, is strung on the central axle on the heat wheel side, 3301.

There is thick superconductive one-sided insulated plating, 2628, on each housing that has a magnetic bearing inside it. Behind each thick superconductive one-sided insulated plating, 2628, is a hollow area to route coolant to keep the thick superconductive one-sided insulated plating, 2628, superconductive.

The large coupling wheel, 2525, is magnetically coupled to the small coupling wheels, 2522.

Connecting the turbine and pump is the turbine exhaust to pump intake pipe, 2008. Connecting the pump and heat exchanger is the pump exhaust to heat exchanger intake pipe, 2009. The heat exchanger, 2216, is then connected to the heat wheel housing, 2003, by another pipe, drawn to small to see its length. Also going in and out of the heat exchanger, 2216, is the secondary heat exchanger intake pipe, 2006, and the secondary heat exchanger exhaust pipe, 2007.

There are two coolant loops. One loop for central cooling and another loop for cooling the components for each turbine addition to the engine. The coolant for cooling the components for each turbine is first expelled through the exhaust loft, 2217, and into the pump exhaust to magnetic bearing housing B coolant pipe, 2113, and then into the magnetic bearing housing B, 3302. The coolant leaves magnetic bearing housing B, 3302, through magnetic bearing housing B to magnetic bearing housing C coolant pipe, 2010, and into magnetic bearing housing C, 3303. The coolant leaves magnetic bearing housing C, 3303, through a magnetic bearing housing C to superconducting magnet coolant pipe, 2011, and enters a superconducting magnet, 2215. The coolant exits the superconducting magnet, 2215, through a superconducting magnet to heat exchanger coolant pipe, 2012, and enters a heat exchanger, 2216, to be mixed back into the main fluid flow within the heat exchanger, 2216.

The coolant for central cooling is pumped from one or more exhaust lofts, 2217, so as to minimize temperature differences between fluid flows through individual turbine systems by using more than one loft. However, coolant for central cooling is shown pumped through only one exhaust loft for simplicity. Coolant for central cooling leaves exhaust loft, 2217, and goes through a pump exhaust to magnetic bearing housing A coolant pipe, 2831, and then enters into a magnetic bearing housing A, 2114. The coolant leaves magnetic bearing housing A, 2114, through a magnetic housing A to heat wheel housing inlet coolant pipe, 2832, and enters into the heat wheel housing, 2003. The coolant leaves the heat wheel housing, 2003, through a heat wheel housing outlet to heat exchanger inlet coolant pipe, 2832, and enters a heat exchanger, 2216, where the coolant is mixed back into the main fluid flow within the heat exchanger, 2216.

There are fluid chambers in the heat wheel, 2730, and supersonic nozzles, 3035, which pass fluid from the heat wheel into the turbine, 2421. Two cross-sections of the supersonic nozzles, 3035, are taken in FIG. 31D and FIG. 30C. Seven supersonic nozzles, 3035, are aligned on top of each other in FIG. 30C. There are as many supersonic nozzles, 3035, as are needed to pass fluid flow upon the whole width of a turbine, 2421.

A nozzle has an Areaₑₓᵢₜ/Areaₜₕᵣₒₐₜ of 4 and an Areaₜₕᵣₒₐₜ of 3.76 mm̂2 for the embodiment depicted but there are infinite choices. The pressure_{back}/Pressure_{chamber} is at least 0.25 or smaller for supersonic air flow.

Small coupling wheels, 2522, are magnetically coupled in a planetary gear system to the external coupling frame, 1903. Turbines could alternatively be coupled externally individually, as is done in the first embodiment, to increase torque if higher torque is wanted. Alternatively, another small coupling wheel could be added vertically to meet with another layered section of the external coupling frame to increase torque if higher torque is wanted.

### Operation—Fourth Embodiment

This embodiment is functionally the same as the first, but with more turbines. The fluid, a mixture of magnetocaloric powder and ethane starts out in the chambers of the large heat wheel, 2730, and goes into the turbine housing, 2934, to impart momentum upon the turbine, 2421. The fluid is propelled into a turbine housing, 2934, under its own pressure due to heating of the magnetocaloric powder as the fluid inside the heat wheel chambers slides under superconducting magnets, 2215. The fluid is pressurized by the magnetocaloric powder heating up the ethane in a nearly closed chamber.

As the fluid goes from the large heat wheel, 2730, to a turbine, 2421, the fluid passes through supersonic nozzles, 3035. These supersonic nozzles, 3035, do two things. The supersonic nozzles, 3035, increase the momentum of the fluid so that more energy can be transferred from the fluid to the turbine, 2421. The supersonic nozzles, 3035, also cool the fluid by a very significant fraction to a temperature, set by nozzle parameters, far below the fluids starting temperature. This lost heat energy is transferred into fluid momentum that can be extracted by the turbine, 2421. This is convenient since this process is repeatable by heating the fluid back to its starting temperature through a heat exchanger, 2216.

After the fluid imparts energy to the turbine, 2421, the fluid is sucked through the turbine exhaust to pump intake pipe, 2008, and into the small pump housing, 2005, by the centrifugal pump, 2320. The centrifugal pump, 2320, then pushes the fluid through the pump exhaust to heat exchanger intake pie, 2009. and through the heat exchanger, 2216, and back into the large heat wheel, 2739. As the fluid passes through the heat exchanger, 2216, the fluid is heated back to its starting temperature before the fluid came under a superconducting magnet, 2215. The heat exchanger, 2216, has secondary heat exchanger intake and exhaust pipes, 2006 & 2007, so that the heat exchanger, 2216, can heat the inner fluid by an outer fluid. The fluid passes from the heat exchanger, 2216, into the chambers of the large heat wheel, 2730. Since the chambers will be at a lower fluid density due to some of the fluid inside the chambers having already been expelled into the turbine housing, 2934, the fluid easily passes from the heat exchanger, 2216, and into the large heat wheel, 2730.

This embodiment has the capability to cool its own superconductors by using ethane vapor and high temperature superconductors. The starting temperature can be 216 Kelvin at density 502 Kg/M̂3. This allows a large temperature span to extract energy from that would produce 14,700 HP at 42% turbine efficiency if all the heat energy was extracted from 216 Kelvin down to near the fluid's melting point at just over 90 Kelvin. This is with six turbines that each have a mass flow rate of 9.8 Kg/s. The cold temperature reached allows for the high temperature superconductors to be cooled by the engine's exhaust streams.

Peripheral coolant runs from an exhaust loft, 2217, through a pump exhaust to magnetic bearing housing B coolant pipe, 2113, to cool a magnetic bearing housing B, 3302. The coolant then travels through another pipe to cool a magnetic bearing housing C, 3303. Next the coolant runs through another pipe to cool its nearest superconducting magnet, 2215. The coolant then rejoins the main fluid stream by entering the nearest heat exchanger, 2216, to go back into the large heat wheel, 2730.

Central coolant runs from one or more exhaust lofts, 2217, through a pump exhaust to magnetic bearing housing A coolant pipe, 2831, and into a central magnetic bearing housing A, 2114. The coolant exits through the magnetic bearing housing A to heat wheel housing inlet coolant pipe, 2832, and into the heat wheel housing, 2003. The coolant exits the housing through a heat wheel housing outlet to heat exchanger inlet coolant pipe, 2833, and enters a heat exchanger, 2216, to rejoin back into a main fluid stream to go back into the large heat wheel, 2730.

An axle on the turbine side, 3300, is coupled to the central axle on the heat wheel side, 3301, by magnetic coupling of a large coupling wheel, 2525, and a small coupling wheel, 2522. Centrifugal pumps, 2320, are coupled to the central axle on the heat wheel side, 3301, by magnetic coupling of medium coupling wheels, 2524.

Each wheel has an axle and each axle has at least one magnetic bearing wheel, 2523. The central axle on the heat wheel side, 3301, has four bearings. An axle on the turbine side, 3300, has two bearings. Axles that the centrifugal pumps, 2320, rotate upon, only have one bearing.

The speed of the large heat wheel is limited by how much the fluid, inside a heat wheel chamber, exerts a centripetal force upon the supersonic nozzles, 3035. This centripetal force is exponentially reduced by enlarging the radius of the heat wheel. A possible large heat wheel, 2730, size is a radius of 0.84 meters which only has a centripetal force of 15 lb force for an RPM rate of 150,000.

A heat exchanger, 2216, would need at least a surface area of 3.5 m̂2 at 35 W(/m̂2*K), at 700 m̂2/m̂3, at a 180 Kelvin temperature change. An easy way to keep the temperature recouped by the heat exchanger constant is by varying the length that the fluid must flow through the heat exchanger. This can be done electronically by a parallel stream operated by a valve with a thermocouple and a microprocessor.

In FIG. 32, six small coupling wheels, 2522, couple magnetically to an external coupling frame, 1902. The external coupling frame, 1902, provides power outside of the engine.

All parts of the engine are sealed from the outer environment. The turbine axles are sealed between housings in shaft conduits.

### CONCLUSION, RAMIFICATIONS, AND SCOPE

Besides the aforementioned uses, a refrigeration device could also be used to get water through condensation out of the air, and hence be a water source in places with little clean water. Another use is that this engine could be used in space if energy was focused at it. Even though the average temperature in space is only 3 Kelvin, my engine could operate close to this extreme with a helium atmosphere and especially with a little extra heat focused from mirrors or from a nuclear power source. Close orbit satellites would be easier to power than in other areas of space since the ambient temperature is warmer in close orbit. Another very important use is the cooling of superconductors such as superconducting power lines and superconductive maglev train rail systems and superconductive power generation systems.

Novel systems are also possible like an electrical generator composed of a Faraday disk rotating inside a superconducting magnet assembly to produce incredible power output, from a very small space, that is transmitted virtually loss-less by superconducting power lines, all cooled and powered by this engine. A Faraday disk is a good generator for use in transmitting power by superconductors since it behaves as a current source by generating very low voltage and very high amperage, which is similar to the voltage and amperage at which superconductors conduct. This same novel system can charge a car mechanically while the owner is out of the house and power the house electrically while the owner is home. Of course, the owner would have more power than he or she needs to power a home so excess power can be supplied into the power grid since an engine powerful enough to power a car is also powerful enough to power a whole subdivision of houses. In this way, this engine could end the need of power supplied by power companies; and, power companies would only need to provided electrical connections between houses with superconductors cooled by this engine.

Many different engine types can be converted to this type of invention. The engines depicted have been optimized for this invention.

This embodiment's engine can be fuel-less or fueled. This engine can also have 100% fuel efficiency or greater. Fuel-less versions can run on ambient air or other forms of ambient heat, even if those forms are below 0 degrees Celsius due to the engines very low operating temperature. This engine has a very high power density compared to engines of similar volumetric size. This engine can refrigerate at very high thermal energy transfer rates compared to other refrigerators. This engine uses thermal energy gained by refrigeration to produce mechanical or electrical power. This engine can produce power ranging from power needed by very small engine applications to power needed by power plant applications.

While the above description contains many specificities, these should not be construed as limitations on the scope of any embodiment, but as exemplifications of various embodiments thereof. Many other ramifications and variations are possible within the teachings of the various embodiments. Thus the scope should be determined by the appended claims and their legal equivalents, and not by the examples.

1. A method of producing work from thermal energy comprising:
a. At least one magnet, 1594, and
b. at least one expansion/compression chamber, 1595, and
c. a magnetocaloric powder, 1596, and
d. a means for change, 1593, in magnetic field, perceived by said magnetocaloric powder, within said expansion/compression chamber.
